(19) United States
(12) Patent Application Publication
(10) Pub. No.: US 2025/0141758 A1
(43) Pub. Date: May 1, 2025

(54) UE CLUSTERING IN FL MODEL UPDATE REPORTING

(71) Applicant: QUALCOMM Incorporated, San Diego, CA (US)

(72) Inventors: Yuwei REN, Beijing (CN); Huilin XU, Temecula, CA (US); June NAMGOONG, San Diego, CA (US)

(21) Appl. No.: 18/683,231

(22) PCT Filed: Oct. 12, 2021
(86) PCT No.: PCT/CN2021/123187

§ 371 Date: Feb. 12, 2024

(51) Int. Cl. H04L 41/16; H04W 24/02; H04W 72/25

(52) U.S. Cl. CPC H04L 41/16; H04W 24/02; H04W 72/25

(57) ABSTRACT

This disclosure provides systems, devices, apparatus, and methods, including computer programs encoded on storage media, for FL model update reporting based on UE clustering. A UE may receive, from a base station, one or more criteria for grouping a plurality of UEs into a UE group for a combined machine learning model update. The UE may receive, from one or more UEs in the UE group, individual machine learning model updates for a machine learning model and transmit the combined machine learning model update to the base station based on the individual machine learning model updates from the one or more UEs.

### INTRODUCTION

The present disclosure relates generally to communication systems, and more particularly, to federated learning (FL) reporting techniques.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communication (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, an apparatus for wireless communication at a wireless device that supports sidelink communication is provided user equipment (UE) is provided. The apparatus includes a memory and at least one processor coupled to the memory, the memory and the at least one processor are configured to receive, from a base station, one or more criteria for grouping a plurality of UEs into a UE group for a combined machine learning model update; receive, from one or more UEs in the UE group, individual machine learning model updates for a machine learning model; and transmit the combined machine learning model update to the base station based on the individual machine learning model updates from the one or more UEs.

In another aspect of the disclosure, a method of wireless communication at a UE is provided. The method includes receiving, from a base station, one or more criteria for grouping a plurality of UEs into a UE group for a combined machine learning model update; receiving, from one or more UEs in the UE group, individual machine learning model updates for a machine learning model; and transmitting the combined machine learning model update to the base station based on the individual machine learning model updates from the one or more UEs.

In another aspect of the disclosure, an apparatus for wireless communication at a UE is provided. The apparatus includes means for receiving, from a base station, one or more criteria for grouping a plurality of UEs into a UE group for a combined machine learning model update; means for receiving, from one or more UEs in the UE group, individual machine learning model updates for a machine learning model; and means for transmitting the combined machine learning model update to the base station based on the individual machine learning model updates from the one or more UEs.

In another aspect of the disclosure, a non-transitory computer-readable storage medium is provided for wireless communication at a UE. The non-transitory computer-readable storage medium stores computer executable code, the code when executed by at least one processor causes the at least one processor to receive, from a base station, one or more criteria for grouping a plurality of UEs into a UE group for a combined machine learning model update; receive, from one or more UEs in the UE group, individual machine learning model updates for a machine learning model; and transmit the combined machine learning model update to the base station based on the individual machine learning model updates from the one or more UEs.

In an aspect of the disclosure, an apparatus for wireless communication at a UE is provided. The apparatus includes a memory and at least one processor coupled to the memory, the memory and the at least one processor are configured to receive, from a base station, one or more criteria for grouping a plurality of UEs into a UE group for a combined machine learning model update; join the UE group based on the one or more criteria from the base station; and transmit an individual machine learning model update from the UE to a designated UE for the UE group.

In another aspect of the disclosure, a method of wireless communication at a UE is provided. The method includes receiving, from a base station, one or more criteria for grouping a plurality of UEs into a UE group for a combined machine learning model update; joining the UE group based on the one or more criteria from the base station; and transmitting an individual machine learning model update from the UE to a designated UE for the UE group.

In another aspect of the disclosure, an apparatus for wireless communication at a UE is provided. The apparatus includes means for receiving, from a base station, one or more criteria for grouping a plurality of UEs into a UE group for a combined machine learning model update; join the UE group based on the one or more criteria from the base station; and means for transmitting an individual machine learning model update from the UE to a designated UE for the UE group.

In another aspect of the disclosure, a non-transitory computer-readable storage medium is provided for wireless communication at a UE. The non-transitory computer-readable storage medium stores computer executable code, the code when executed by at least one processor causes the at least one processor to receive, from a base station, one or more criteria for grouping a plurality of UEs into a UE group for a combined machine learning model update; join the UE group based on the one or more criteria from the base station; and transmit an individual machine learning model update from the UE to a designated UE for the UE group.

In an aspect of the disclosure, an apparatus for wireless communication at a base station is provided. The apparatus includes a memory and at least one processor coupled to the memory, the memory and the at least one processor are configured to transmit one or more criteria for grouping a plurality of user equipments (UEs) into a UE group for a combined machine learning model update; and receive the combined machine learning model update from at least one group of UEs.

In another aspect of the disclosure, a method of wireless communication at a base station is provided. The method includes transmitting one or more criteria for grouping a plurality of user equipments (UEs) into a UE group for a combined machine learning model update; and receiving the combined machine learning model update from at least one group of UEs.

In another aspect of the disclosure, an apparatus for wireless communication at a base station is provided. The apparatus includes means for transmitting one or more criteria for grouping a plurality of user equipments (UEs) into a UE group for a combined machine learning model update; and means for receiving the combined machine learning model update from at least one group of UEs.

In another aspect of the disclosure, a non-transitory computer-readable storage medium is provided for wireless communication at a base station. The non-transitory computer-readable storage medium stores computer executable code, the code when executed by at least one processor causes the at least one processor to transmit one or more criteria for grouping a plurality of user equipments (UEs) into a UE group for a combined machine learning model update; and receive the combined machine learning model update from at least one group of UEs.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating aspects of machine learning (ML) in wireless communication, in accordance with various aspects of the present disclosure.

FIG. 5 is a communication diagram showing example aspects of federated learning (FL) at a wireless network, in accordance with various aspects of the present disclosure.

FIG. 6 illustrates a diagram of FL model update reporting based on a global FL model broadcast, in accordance with various aspects of the present disclosure.

FIG. 7 illustrates a diagram for broadcasting a global FL model and receiving an FL model update based on the global FL model, in accordance with various aspects of the present disclosure.

FIG. 8 is a diagram showing an example in which multiple UEs may provide similar, or the same, ML features for an updated global model, in accordance with various aspects of the present disclosure.

FIG. 9 is a communication flow including UE groups for reporting ML model update reporting, in accordance with various aspects of the present disclosure.

FIG. 10 is a diagram illustrating multiple UE groups for ML model update reporting, in accordance with various aspects of the present disclosure.

FIG. 11 is a communication flow including UE groups for reporting ML model update reporting, in accordance with various aspects of the present disclosure.

FIG. 12 is a communication flow including UE groups for reporting ML model update reporting, in accordance with various aspects of the present disclosure.

FIG. 13 is a flowchart of a method of wireless communication at a UE, in accordance with various aspects of the present disclosure.

FIG. 14 is a flowchart of a method of wireless communication at a UE, in accordance with various aspects of the present disclosure.

FIG. 15 is a flowchart of a method of wireless communication at a UE, in accordance with various aspects of the present disclosure.

FIG. 16 is a flowchart of a method of wireless communication at a UE, in accordance with various aspects of the present disclosure.

FIG. 17 is a flowchart of a method of wireless communication at a base station, in accordance with various aspects of the present disclosure.

FIG. 18 is a flowchart of a method of wireless communication at a base station, in accordance with various aspects of the present disclosure.

FIG. 19 is a diagram illustrating an example of a hardware implementation for an example apparatus, in accordance with various aspects of the present disclosure.

FIG. 20 is a diagram illustrating an example of a hardware implementation for an example apparatus, in accordance with various aspects of the present disclosure.

FIG. 21 illustrates example aspects of a sidelink slot structure, that may be used in accordance with various aspects of the present disclosure.

### DETAILED DESCRIPTION

A machine learning model or neural network may be trained, such as training based on supervised learning. During training, the machine learning model may be presented with an input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target.

Federated learning (FL) may be applied in wireless communication systems that exchange wireless transmissions between a network and distributed UEs. The network may provide the UEs with one or more machine learning models. Each of the UEs may train the received model based on its local data, and may provide the network with reports about the model training based on their local data. For example, the UEs may provide machine learning model updates based on their training. A machine learning model manager may update a global machine model using the updates received from the UEs and may transmit an updated machine learning model to be used by the UEs. As an example, the ML model manager may converge the updated models received from the UEs to update the machine learning model. In some aspects, the machine learning model manager may broadcast the updated machine learning model. There may be many UEs with updated model information to report to the network, and each model may be relatively large in size, e.g., including information about 1,000 to 1 million parameters or more. Multiple models may be used to adapt to different tasks at the UE and different conditions, and the UE may provide updates for the multiple models to the network. In addition to model size and/or the number of models, varying conditions within an environment may cause frequent FL training procedures. The UE reports with the machine learning update information may use a significant amount of uplink resources, especially for the UL/DL asymmetric slot formats where the uplink resources are limited.

Aspects presented herein enable the UEs to provide the network with machine learning model update information based on local training at the UEs in a more efficient manner, in some aspects. The UEs may establish UE groups for the purpose of providing machine learning model updates to the network. In some aspects, the UE groups may be established based on criteria, which may be provided by the network, and which indicates that the UEs may have similar machine learning model update information to provide to the network. One of the UEs may be designated to provide a combined machine learning update report for the UE group, in some examples. In some aspects, the UEs in the group may provide their machine learning model updates to the designated UE, e.g., over sidelink, and the designated UE may perform an analysis of the individual machine learning model updates from the UEs in the UE group to identify meaningful features to report to the network. The designated UE may then report the meaningful features to the network. By providing a single update for the group of UEs, the uplink resource cost for federated learning in the wireless communication system may be reduced, in some aspects. Additionally, or alternatively, by gathering and comparing machine learning model updates from multiple UEs in the group, the designated UE may be able to identify the meaningful features to be reported to the network, whereas an individual UE may not have the comparison information. In some examples, the designated UE may then report a reduced amount of machine learning model update information, which is identified as being meaningful based on the comparison of the update information from the individual UEs of the UE group.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically crasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components, end-user devices, etc. of varying sizes, shapes, and constitution.

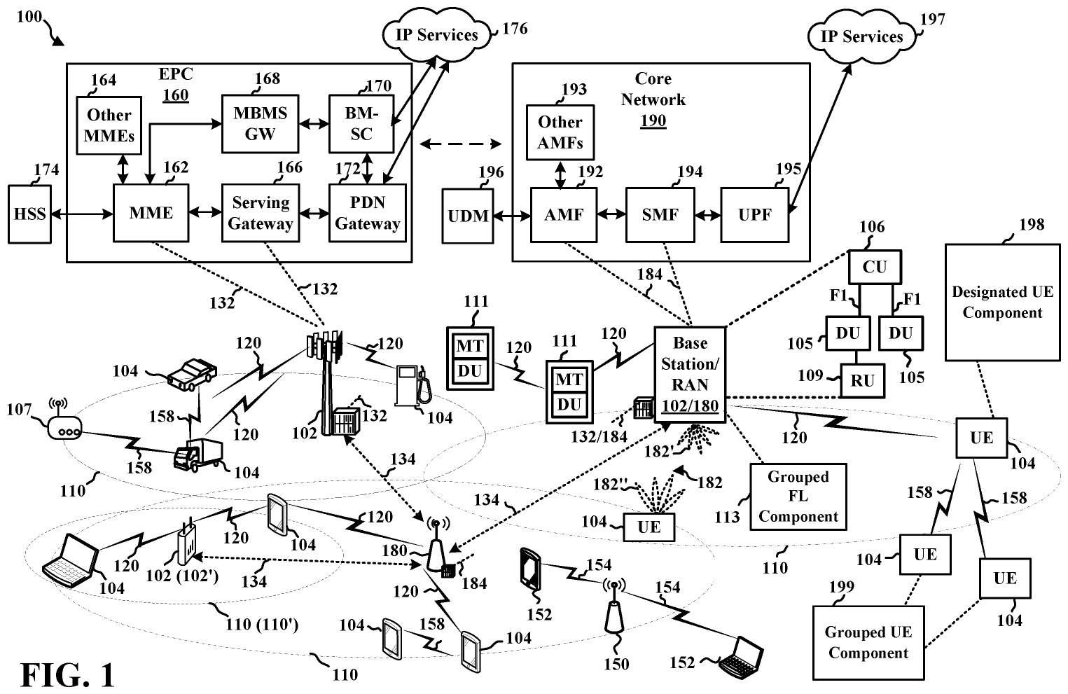

FIG. 1 is a diagram illustrating an example of a wireless communications system and an access network 100. The wireless communications system (also referred to as a wireless wide area network (WWAN)) includes base stations 102, user equipments (UEs) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184 (e.g., Xn interface), and the third backhaul links 134 may be wired or wireless.

In some aspects, a base station 102 or 180 may be referred as a RAN and may include aggregated or disaggregated components. As an example of a disaggregated RAN, a base station may include a central unit (CU) 106, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs 105 may be connected via an F1 interface. A DU 105 and an RU 109 may be connected via a fronthaul interface. A connection between the CU 106 and a DU 105 may be referred to as a midhaul, and a connection between a DU 105 and an RU 109 may be referred to as a fronthaul. The connection between the CU 106 and the core network may be referred to as the backhaul. The RAN may be based on a functional split between various components of the RAN, e.g., between the CU 106, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 106 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 106 and a DU 105. IAB nodes 111 may include a DU 105 and a mobile termination (MT). The DU 105 of an IAB node 111 may operate as a parent node, and the MT may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage arca 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2,which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, cNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a UE 104 may include a designated UE component 198 configured to receive, from a base station 102 or 180, criteria for grouping, or clustering, UEs for a combined machine learning model update. The designated UE component 198 may be further configured to receive individual machine learning model updates from one or more UEs and to transmit the combined machine learning model update to the base station, or other network component, based on the individual machine learning model updates from the one or more UEs. One of more of the UEs 104 may include a grouped UE component 199 configured to receive, from a base station, criteria for grouping UEs for a combined machine learning model update; and transmit an individual machine learning model update from the UE to a designated UE for a group of UEs based on the criteria from the base station. In certain aspects, the base station 180 may include a grouped FL component 113 configured to transmit criteria for grouping UEs for a combined machine learning model update and to receive the combined machine learning model update from at least one group of UEs. Although the following description may be focused on 5G NR, the concepts described herein may be applicable to other similar areas, such as LTE, LTE-A, CDMA, GSM, and other wireless technologies.

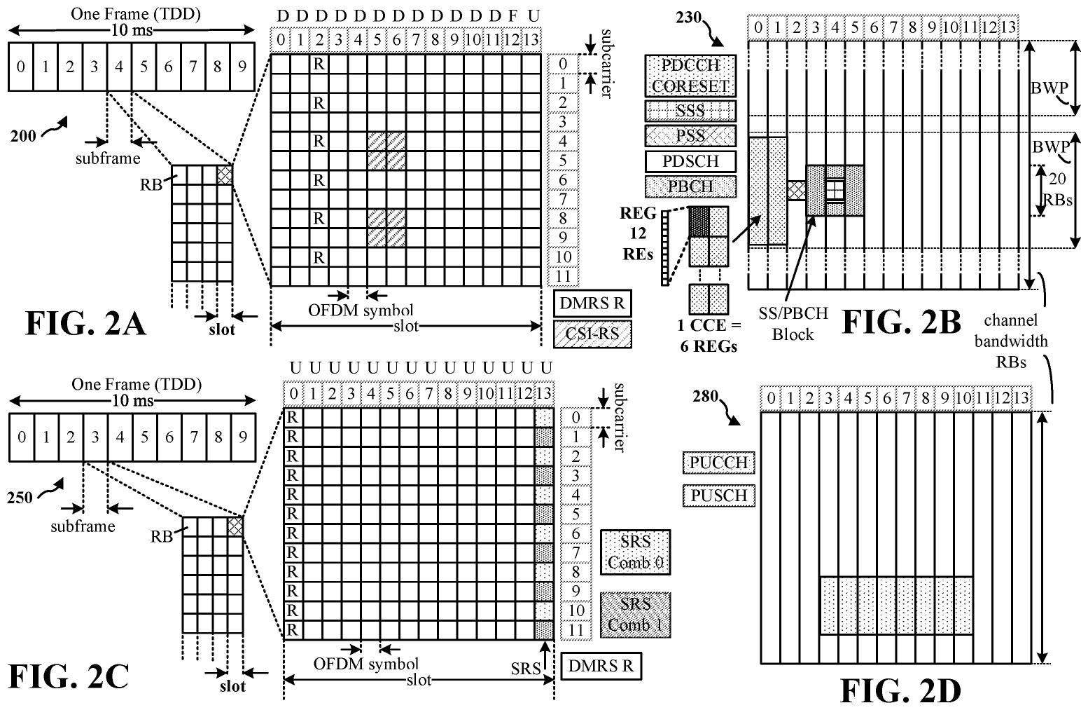

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

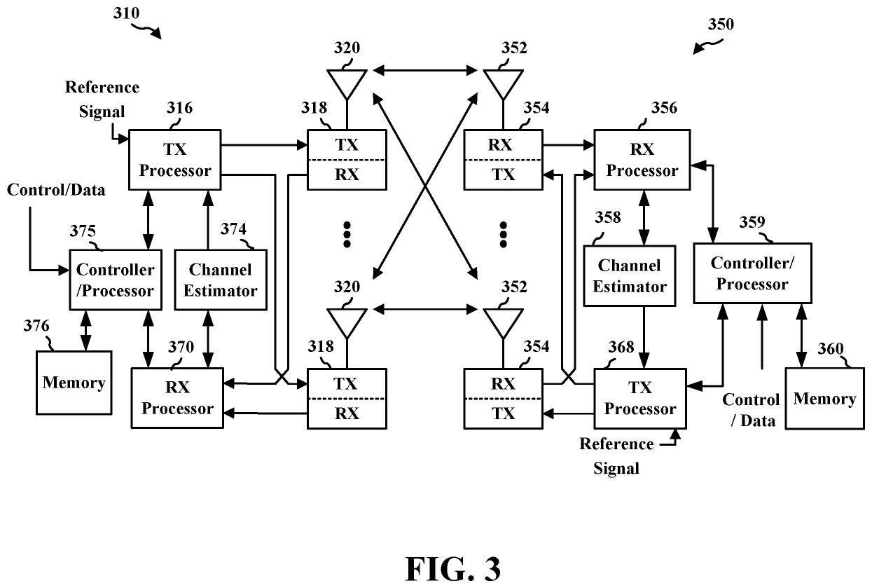

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the designated UE component 198 and/or the grouped UE component 199 of FIG. 1.

At least one of the TX processor 316, the RX processor 370, and the controller/processor 375 may be configured to perform aspects in connection with grouped FL component 113 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and ultra-reliable low latency communication (URLLC) may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

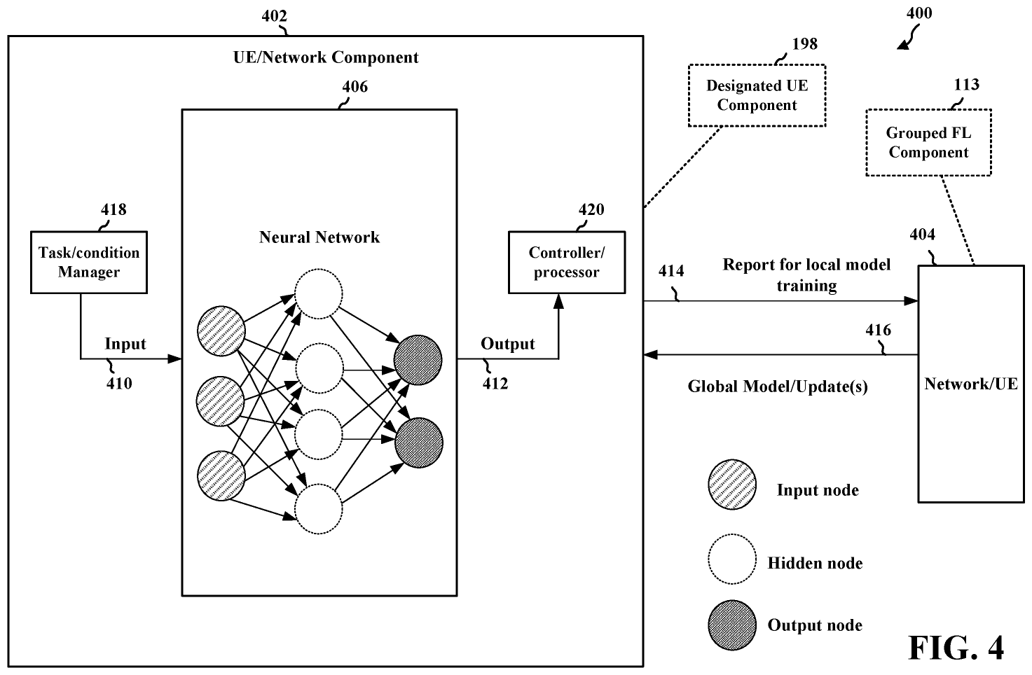

FIG. 4 illustrates a diagram 400 of a first wireless communication device 402 that includes a neural network 406 configured for determining communications with a second device 404. In some aspects, the neural network 406 may be included in a UE. The first wireless communication device 402 may be a UE, and the second device 404 may correspond to a second UE, a base station, or other network component, such as a core network component. In some aspects, the neural network 406 may be included in a network component. The first wireless communication device 402 may be one network component, and the second device 404 may be a second network component. A UE and/or a base station (e.g., including a (CU) and/or a distributed unit (DU)) may use machine-learning algorithms, deep-learning algorithms, neural networks, reinforcement learning, regression, boosting, or advanced signal processing methods for aspects of wireless communication, e.g., with a base station, a TRP, another UE, etc. The CU may provide higher layers of a protocol stack, such the SDAP, PDCP, RRC, etc., while the DU may provide lower layers of the protocol stack, such as the RLC, MAC, PHY, etc. A single CU may control multiple DUs, and each DU may be associated with one or more cells.

Reinforcement learning is a type of machine learning that involves the concept of taking actions in an environment in order to maximize a reward. Reinforcement learning is a machine learning paradigm; other paradigms include supervised learning and unsupervised learning. Basic reinforcement may be modeled as a Markov decision process (MDP) having a set of environment and agent states, and a set of actions of the agent. The process may include a probability of a state transition based on an action and a representation of a reward after the transition. The agent's action selection may be modeled as a policy. The reinforcement learning may enable the agent to learn an optimal, or nearly-optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples. Federated learning (FL) procedures that use edge devices as clients may rely on the clients being trained based on supervised learning.

Regression analysis may include statistical processes for estimating the relationships between a dependent variable (e.g., which may be referred to as an outcome variable) and independent variable(s). Linear regression is one example of regression analysis. Non-linear models may also be used. Regression analysis may include inferring causal relationships between variables in a dataset.

Boosting includes one or more algorithms for reducing bias and/or variance in supervised learning, such as machine learning algorithms that convert weak learners (e.g., a classifier that is slightly correlated with a true classification) to strong ones (e.g., a classifier that is more closely correlated with the true classification). Boosting may include iterative learning based on weak classifiers with respect to a distribution that is added to a strong classifier. The weak learners may be weighted related to accuracy. The data weights may be readjusted through the process. In some aspects described herein, an encoding device (e.g., a UE, base station, or other network component) may train one or more neural networks to learn dependence of measured qualities on individual parameters.

The second device 404 may be a base station in some examples. The second device 404 may be a TRP in some examples. The second device 404 may be a network component, such as a DU, in some examples. The second device 404 may be another UE in some examples, e.g., if the communication between the first wireless device 402 and the second device 404 is based on sidelink. Although some example aspects of machine learning and a neural network are described for an example of a UE, the aspects may similarly be applied by a base station, an IAB node, or another training host.

Among others, examples of machine learning models or neural networks that may be included in the first wireless device 402 include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with an input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. FIG. 4 illustrates that an example neural network 406 may include a network of interconnected nodes. An output of one node is connected as the input to another node. Connections between nodes may be referred to as edges, and weights may be applied to the connections/edges to adjust the output from one node that is applied as the input to another node. Nodes may apply thresholds in order to determine whether, or when, to provide output to a connected node. The output of each node may be calculated as a non-linear function of a sum of the inputs to the node. The neural network 406 may include any number of nodes and any type of connections between nodes. The neural network 406 may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse a layer multiple times. As an example, the first wireless device 402 may input information 410 to the neural network 406 (e.g., via a task/condition manager 418), and may receive output 412 (e.g., via a controller/processor 420). The first wireless device 402 may report information 414 to the second device 404 based on the output 412. In some aspects, the second device may transmit communication to the first wireless device 402 based on the information 414. In some aspects, the second device 404 may be a base station that schedules or configures a UE (e.g., the first wireless device 402) based on the information 414, e.g., at 416. In other aspects, the base station may collect information from multiple training hosts, e.g., from multiple UEs. Similarly, a network may collect information from multiple training hosts including multiple base stations, multiple IAB nodes, and/or multiple UEs, among other examples.

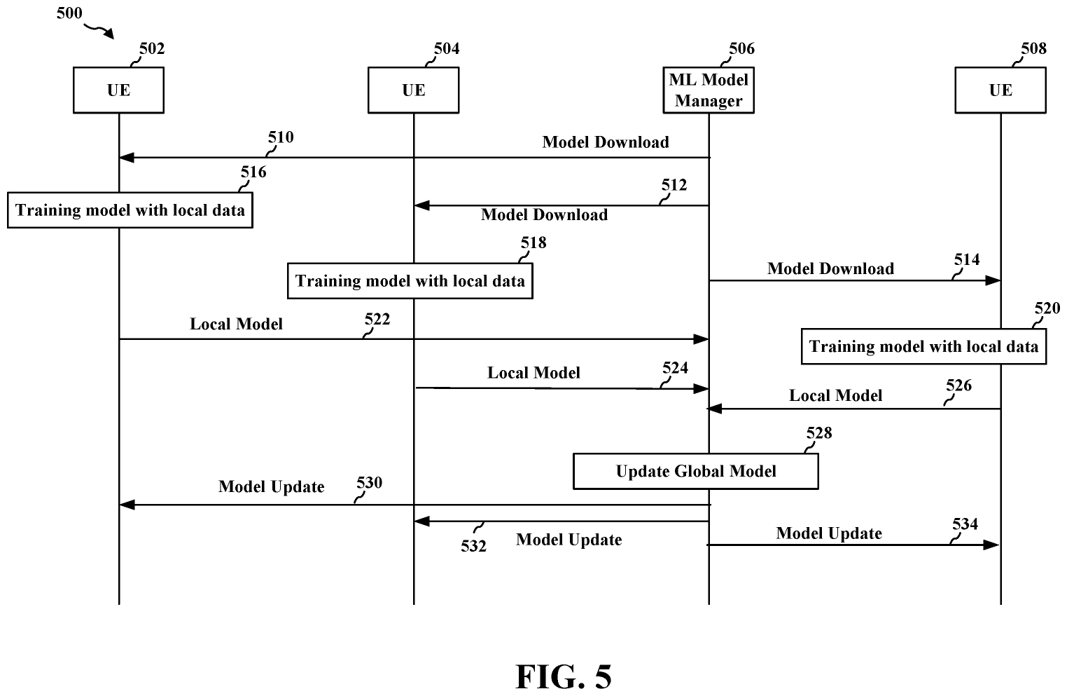

FIG. 5 illustrates an example communication flow 500 between a network component and one or more UEs for FL learning. FL may be applied in wireless communication, and may involve data transmissions between a server (e.g., a node in the network and/or base station) and distributed UEs. The UEs may include any of the examples described in connection with FIG. 1. The network node may include a FL learning manager, which may also be referred to as an ML model manager 506, or by another name. The FL learning illustrated in connection with FIG. 5 may include privacy protection by sharing model information without data sharing (e.g., local data at the UEs). As illustrated at 510, 512, and 514, the ML model manager 506 shares a global model among one or more scheduled UEs (e.g., UEs 502, 504, and/or 508). Although illustrated as three separate transmissions of the model, at 510, 512, and 514, one or more of the transmissions may be a combined transmission to multiple UEs. Each UE trains the received model based on its local data, e.g., at 516, 518, and 520. Each UE independently performs the model training based on their own local data. After the training, the one or more UEs may transmit information about an updated model based on the training performed at the UE. For example, the UEs may report, at 522, 524, and/or 526, an updated mode to the ML model manager 506. The ML model manager may update the global model, at 528, based on the model update(s) received from one or more of the UEs 502, 504, 508. As an example, the ML model manager may converge the updated models (e.g., as received at 522, 524, 526). The ML model manager may apply an averaging algorithm in order to update the global model, at 528. After updating the global model, the ML model manager 506 transmits the updated global model to the UEs, at 530, 532, 534. Although the transmissions are illustrated as separate transmissions, in some aspects, the ML model manager may broadcast the updated global model in a combined transmission that is received by the UEs 502, 504, and 508.

Each of the scheduled UEs may report the updated model information to the server. The model may be relatively large in size, e.g., 1,000 to 1 million parameters or more. Multiple models may be used to adapt to different tasks and different conditions, which may be updated and reported to the base station. In addition to model size and/or the number of models, varying conditions within an environment may cause frequent FL training procedures. In downlink, FL training rounds may be associated with lower resource costs, as the network may broadcast the global FL model one time for a particular FL training round. However, because there may be many different distributed users in uplink, each UE may report the updates individually. Thus, the uplink resource cost via the Uu link may be large, especially for the UL/DL asymmetric slot formats where the UL resource is limited.

The base station may broadcast a global FL model to a plurality of UEs at the same time. After the UEs receive the global model, each UE may train the model based on a local data set. Uplink reporting of the trained model may be based on model size, a number of FL models to be reported, a frequency of FL training events, and/or available uplink resources in configured slots. After the FL model training is performed, each UE may report the model update to the base station. In some cases, uplink model report by each of the UEs may cause a bottleneck in the uplink Uu resources.

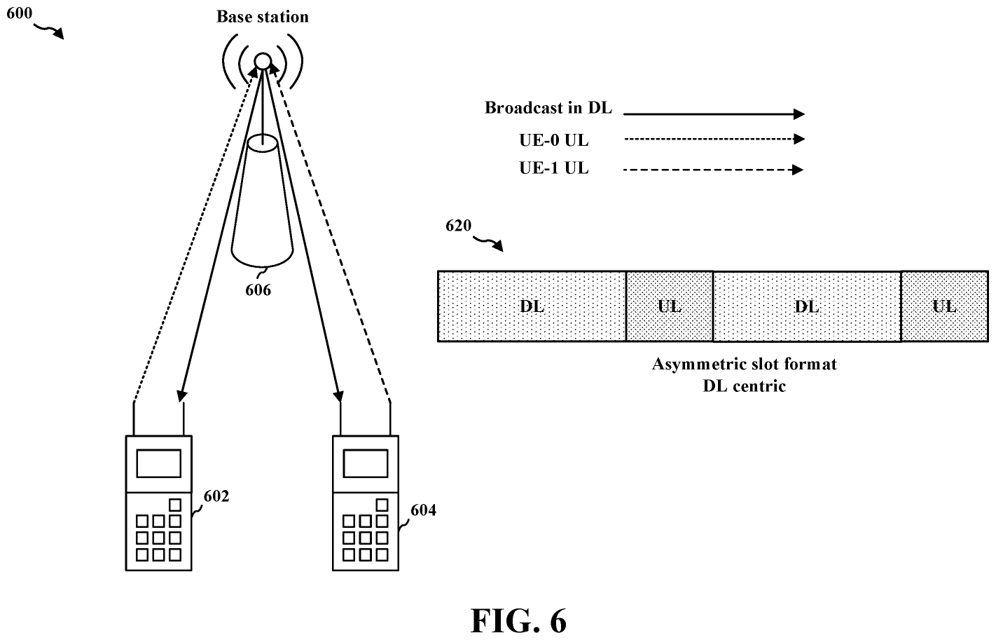

FIG. 6 illustrates a diagram 600 of FL model update reporting based on a global FL model broadcast. FIG. 6 illustrates an example in which the base station 606 may broadcast the global model/global model updates (e.g., as described in connection with FIG. 5) in a single transmission that is received by multiple UEs (e.g., UE 602 and 604), and the UEs individually transmit model updates to the base station 606, e.g., in separate uplink transmissions. FIG. 6 also illustrates that more resources 620 in time and/or frequency may be allocated for downlink transmissions that for uplink transmissions.

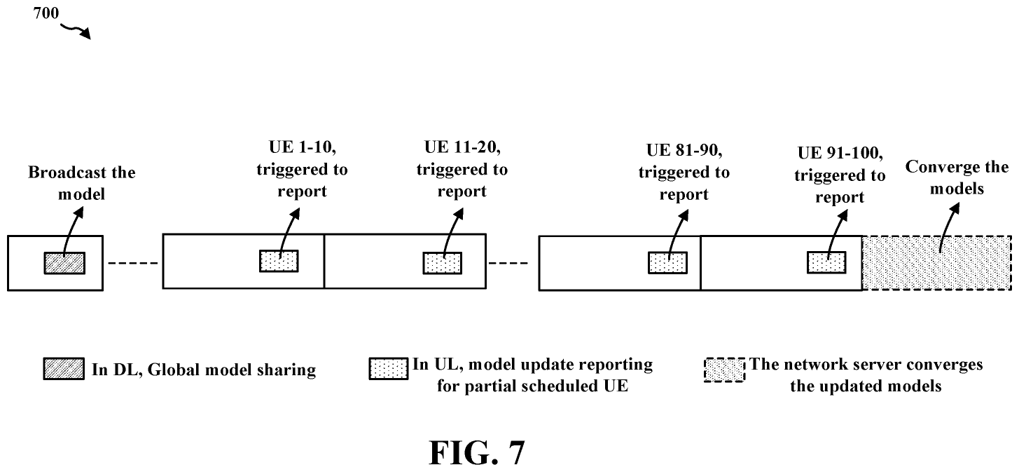

FIG. 7 illustrates a diagram 700 for broadcasting a global FL model and receiving an FL model update based on the global FL model. Model reporting may be associated with high overhead due to the size of information to be transmitted in a report of a model update, especially in environments that have densely scheduled UEs. A periodic time pattern may be set to scan each the scheduled UEs scheduled to report the updated model. For example, if 100 UEs are scheduled for the FL procedure, the UEs may be triggered in groups of 10. FIG. 7 illustrates an example time diagram showing that subsets of the UEs are scheduled to report model updates in a periodic time pattern. After a model reporting cycle, e.g., of the 10 time durations to receive model updates from each of the 100 UEs, the network may converge to an updated global model in one FL cycle. Although each of the UEs is scheduled to provide the model update, and the cycle provides for the model updates to be considered from each UE, the latency may be large in order to provide an opportunity for each of the UEs to report their model updates before updating the global model. In environments or applications with rapidly changing scenarios, a latest updated model might not track the environment variations.

Aspects presented herein provide for a reduced latency in global model updates while maintaining valuable model updates from the UEs. UE clustering may be performed to reduce FL model reporting costs. That is, a plurality of similar UEs may be grouped together into a UE cluster, such that a designated UE of the cluster (e.g., cluster group leader) may report FL model updates and information to the base station, rather than each UE in the cluster reporting the FL model updates on an individual basis. The UEs may be configured as distributed nodes that perform their own local training, and the base station may be a model manager that controls and configures the FL model. Such techniques may be used to increase data privacy/security, as only the FL model updates are shared with the base station from the UEs, and not the local training data set of the UEs.

Local training information may be reported to the network, where each UE in the cluster learns an FL model update based on its own local information, which may enable the FL model to be adapted to different conditions. In a first step of an FL model training procedure, the server may transmits/share a global FL model to a plurality of UEs. Next, each UE may independently train the model based on a local data set of each UE. Each UE may transmit/report the updated FL model to the server via uplink. The server may apply an averaging technique for updating the global model, which may be used to converge the updated FL models. Finally, the server may broadcast the updated global model to all of the UEs in communication with the server. Hence, all of the UEs may receive the updated model based on the local information/data sets. The FL model updates may provide increased data privacy, as the UE is not sending the local data to the server, just the FL model updates.

In FL, an effective new feature that is obtained from a local model update may provide a gain to improve the overall performance of the model, e.g., the global model. In some aspects, multiple UE reports may include similar features, which can be considered repetitive (or less effective) for model updates to the global model. For example, in FIG. 5, the UE 502 and the UE 504 provide similar features to the ML model manager 506, and the multiple transmissions at 522 and 524 may have a similar effect to a single transmission of either 522 or 524 on the global model update.

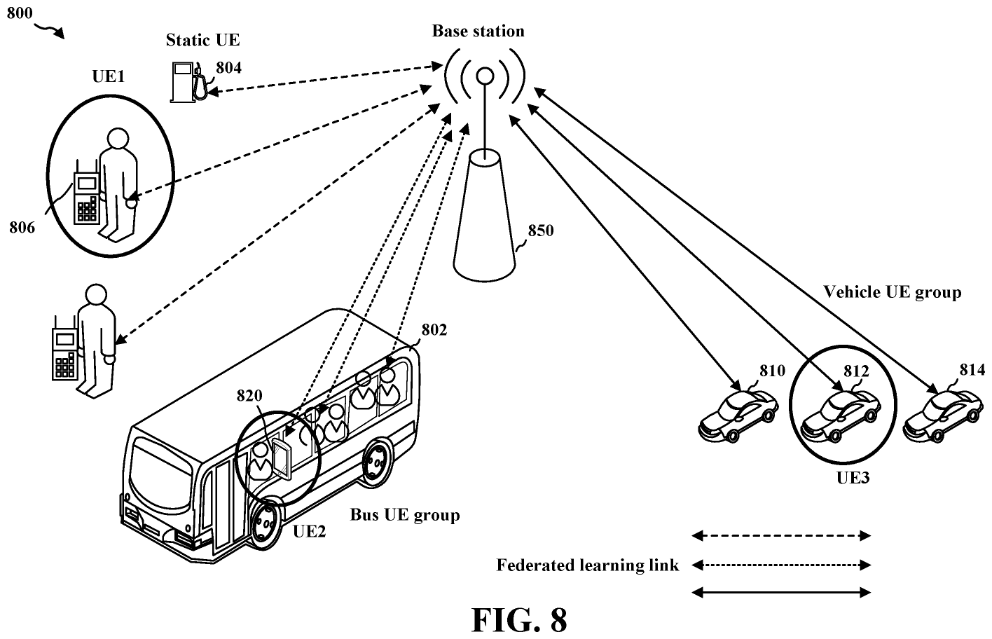

FIG. 8 is a diagram 800 showing an example in which multiple UEs may provide similar, or the same, ML features for an updated global model. As an example, vehicle UEs (e.g., UEs associated with, comprised in, attached, or removable connected with a vehicle) may be located on a road and may experience similar road conditions. FIG. 8 illustrates an example in which vehicles 810, 812, and 814 may have an associated UE (whether incorporated into the vehicle, co-located with/traveling with the vehicle, or removably coupled with the vehicle). The vehicle UEs may provide similar model updates based on their local data. As one, non-limiting example, bus passengers may use UEs. The UEs may be close to each other (e.g., within a bus 802), and may experience similar, or the same, conditions. As the local data at the UEs on the bus may be similar, the updated models reported by the UEs on the bus 802 may be similar.

As another example, a static UE 804 or UE 806 (e.g., which may be at least temporarily static) may experience more constant, e.g., non-varying, conditions. A previous model update transmitted by the static UE 804 may include updated ML model features. If the static UE 804 reports model updates in a periodic manner, the static UE may make repeated transmissions with similar, or the same, model update information. The added transmissions may be duplicative to the ML model manager, and may not further affect global model updates.

The network, and the ML model manager, may not analyze the redundancy of the reported features among various uplink model update reports, until the network receives the various updated models. The repeated and less useful model updates may occupy the Uu uplink resource in FL and delay more useful model updates that may wait for additional Uu uplink resources.

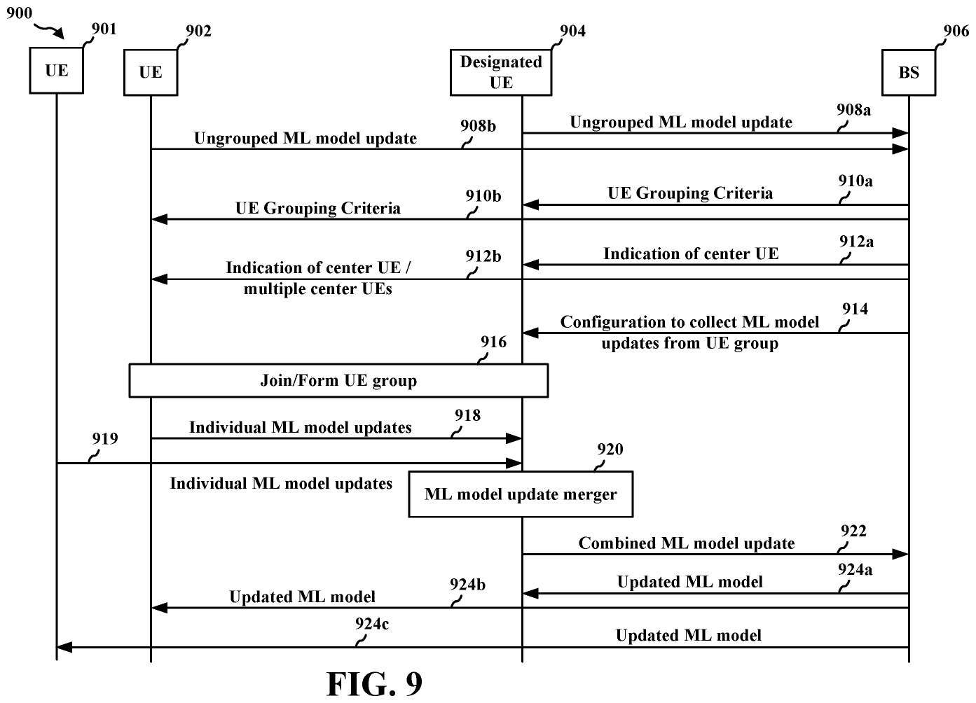

FIG. 9 illustrates an example communication flow diagram 900 showing clustering, or grouping, of UEs to provide improve latency and reduce redundancy and signaling overhead for FL model updates based on local training data while continuing to providing valuable model updates to the network. FIG. 9 illustrates that the UE 902 and the UE 904 may form, or join, a UE group, at 916. Although FIG. 9 only illustrates two UEs, the group may include any number of multiple UEs. The clustering or grouping of UEs for ML model update purposes may reduce redundancy or less valuable model updates or features before reporting model updates to the network. The grouping of UEs based on particular criteria may help to ensure that valuable model updates are still provided to the network with a reduced amount of uplink signaling. The clustering or grouping of UEs for ML model update reporting helps to save uplink resources by reducing the amount of uplink transmission of ML model updates from individual UEs. The UEs may be clustered, or grouped based on criteria that may lead to similar model update features. As a first aspect, the UEs may be scheduled for providing model updates in FL. After grouping, or clustering, UEs into groups, one or more UEs of the cluster/group of UEs may determine which model update to report to the network.

The UEs 902 and/or 904 may apply rules or criteria to determine whether to form a UE group, or whether to join a UE group, for ML model updates in FL. In some aspects, a network may define or configure rules for local clustering of UEs for FL. FIG. 9 shows a network node, such as a base station 906, transmitting UE grouping criteria to the UE 904, at 910a, and to the UE 902, at 910b. In some aspects, the criteria, and other signaling regarding FL, may be from a ML model manager, such as 506 in FIG. 5, and may be transmitted to the UEs via the base station 906. In some aspects, the network may indicate to one or more UEs to join or form a cluster/UE group. For example, the network may indicate to the UE 902 to join a UE group with the UE 904 or may indicate to both of the UEs 902 and 904 to form a UE group.

In some aspects, the network may indicate one or more parameters or criteria for the UE 902 to join a group and/or for the UEs 902 and 904 to form a group. As an example, the network may indicate a range or distance between a scheduled UE (e.g., a UE scheduled to provide model updates for FL) and another UE, such as a designated UE for the UE group. If the range of the scheduled UE to the designated UE is within the range, or distance, the scheduled UE may join the UE group associated with the designated UE. If the scheduled UE is outside the range, or at a distance greater than the range threshold, from the designated UE, the scheduled UE may continue to send an individual ML update report without joining the UE group. In FIG. 9, for example, the UE 902 may join a UE group with the designated UE 904, at 916, based on being within a threshold range or distance of the designated UE 904.

In some aspects, the network may indicate that the parameter/criteria for joining/forming a UE group is a shared scenario ID with the other scheduled UEs in the UE group. As an example, in FIG. 9, the UE 902 may join a UE group with the designated UE 904, at 916, based on being configured to provide model updates for FL for a same scenario (e.g., associated with a scenario ID) as the UE 904. If the UEs were not configured to provide FL model updates for the same scenario, the UEs may continue to provide individual model update reports for their respective scenarios without clustering/forming a UE group. In some aspects, a UE may have a capability to identify at least a part of an applicable scenario. As an example, based on ML, the UE may identify whether a current location is an indoor location and corresponds to an indoor scenario or an outdoor location that corresponds to an outdoor scenario Based on an estimated channel, the UE may identify a channel type, a Doppler feature, a delay spread, among other example parameters for a FL scenario. The UE may determine a corresponding scenario ID for the UE's current situation and may cluster with one or more other UEs having the same scenario ID.

In some aspects, the network may indicate that the parameter/criteria for joining/forming a UE group is being in a same cell with the other scheduled UEs in the UE group. As an example, in FIG. 9, the UE 902 may join a UE group with the designated UE 904, at 916, based on being in a same cell (e.g., with a same cell ID) as the UE 904. If the UEs were in different cells, the UEs may continue to provide individual model update reports for their respective scenarios without clustering/forming a UE group.

In some aspects, the network may indicate that the parameter/criteria for joining/forming a UE group includes a combination of parameters, factors, or criteria, e.g., such as any combination of a range, a shared scenario, being within a same cell, and/or receiving an indication from the base station. In some aspects, there may be a relationship between a cell ID and one or more effective features in FL. In some aspects, a cell ID may be combined with, or may correspond to, a physical position. As an example, a cell ID may be associated with a tunnel or with a particular floor of a building. The UEs within the cell, e.g., having the same cell ID, may hold, or provide similar features for FL in model update reports. Clustering or grouping such UEs may reduce the redundant signaling of model updates reports with the same or similar features.

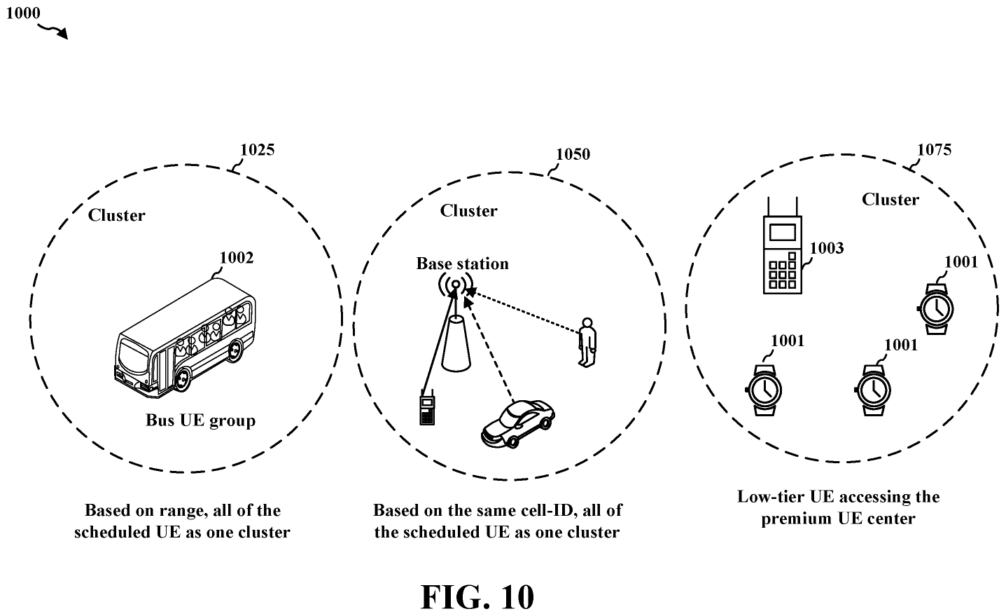

FIG. 10 illustrates a diagram 1000 showing UE groups, or clusters that may be formed based on various types of criteria. A first UE group, or cluster 1025, may be formed or joined based on a range, e.g., with each of the scheduled UEs being within a range of each other and/or of a designated UE. The example cluster 1025 in FIG. 10 illustrates a group of UEs traveling together on a vehicle 1002, such as a bus. In some aspects, the group of UEs in the cluster 1025 may further share a scenario ID and/or cell ID based on the shared travel in a same vehicle. In a second UE group (e.g., cluster 1050), the UEs may form the cluster 1050 and/or join the cluster 1050 based on sharing a same cell ID as the other UEs in the cluster 1050. A third example cluster 1075 in FIG. 10 is formed, or joined, based on a capability of the UEs. For example, one or more lower capability UEs may join a cluster 1075 with a higher capability UE as a designated UE.

The UE 902 may be triggered for clustering, joining a cluster/UE group, or forming a cluster/UE group in response to determining that one or more of the parameters/criteria have been met. Once the UE joins a cluster/UE group, the model updates for each of the UEs in the UE group may be determined and reported by the cluster. If the UE is not triggered to form/join a cluster or UE group, the UE may continue to report individual model updates. As an example, FIG. 9 illustrates that the UE 902 and/or the UE 904 may transmit an ungrouped, e.g., individual, model update at 908b and 908a, prior to joining/forming the UE group at 916.

Although aspects have been described for the UEs to receive the clustering/grouping criteria from the network, in some aspects, one or more of the parameters/criteria may be known to the UEs or defined rather than being received from the network.

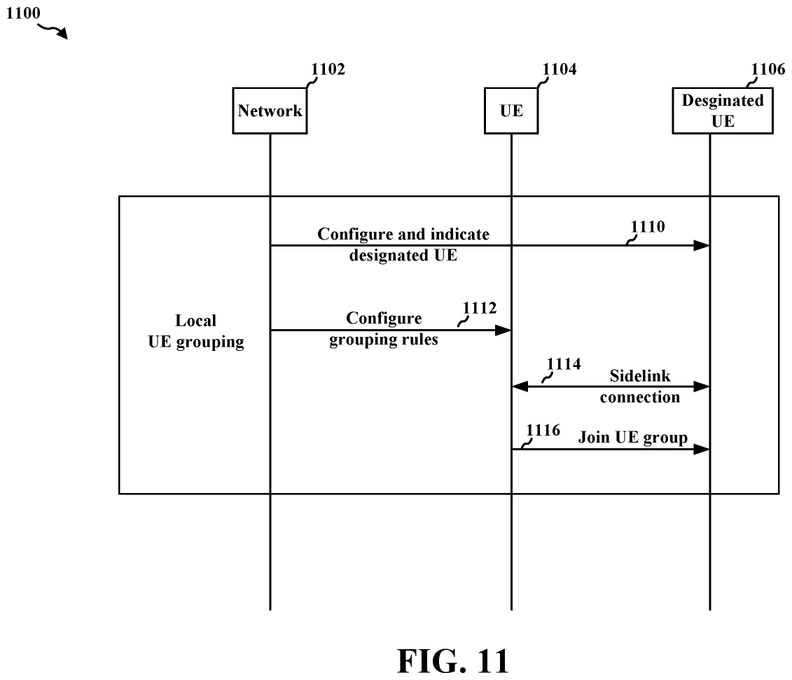

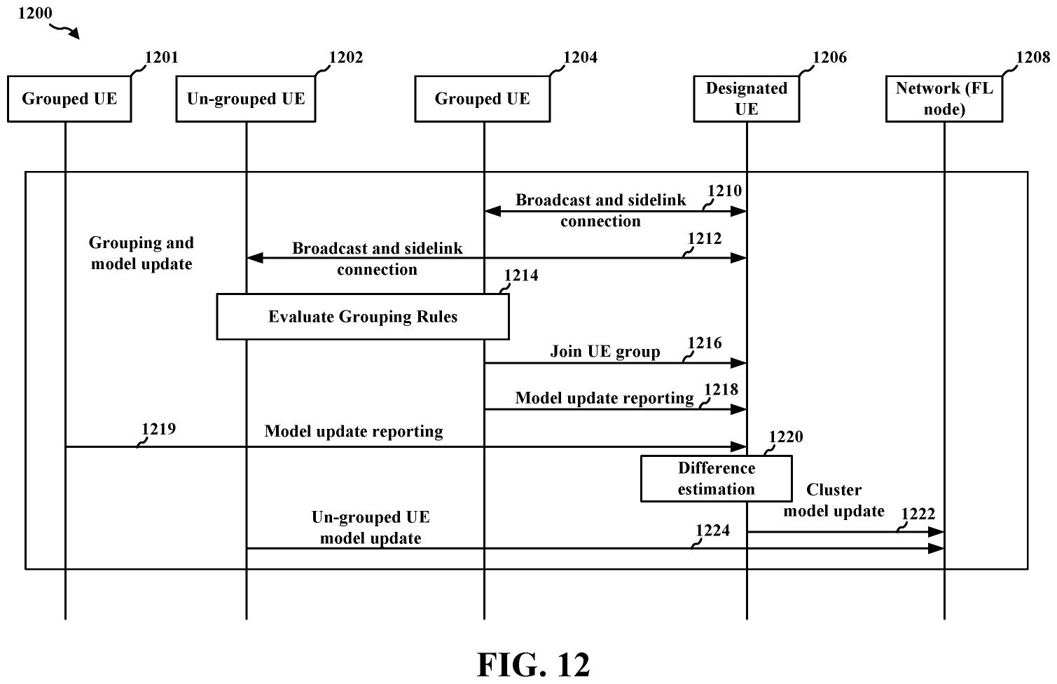

In some aspects, the UEs may follow one or more rules, or criteria, to determine how to form a cluster or UE group. As an example, the UEs 902 and 904 may form the UE group at 916 based on the exchange of one or more sidelink messages, whereas the signaling with the network may be based on an access link, or Uu link. As another example, the UE 902 may join a UE group with the UE 904 through the exchange of one or more sidelink messages. FIGS. 11 and 12 illustrate example aspects of signaling in order to join, or form, a UE group for model update reporting.

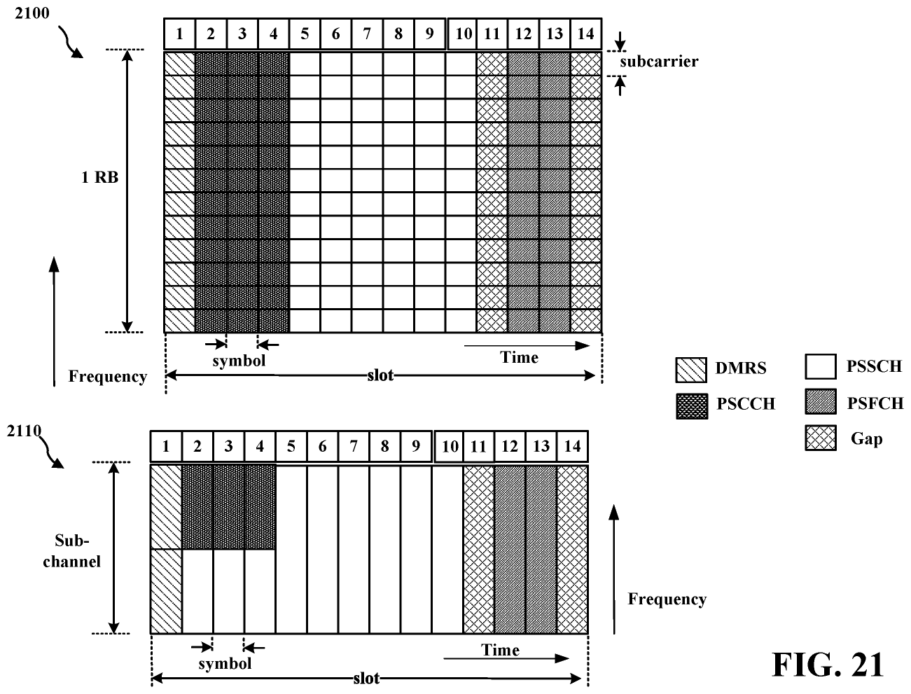

FIG. 21 illustrates an example slot structure FIG. 21 includes diagrams 2100 and 2110 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 21 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 2100 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 2110 in FIG. 21 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 21, some of the REs may include control information in PSCCH and some REs may include demodulation RS (DMRS). At least one symbol may be used for feedback. FIG. 21 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 21. Multiple slots may be aggregated together in some aspects.

In some aspects, the UE 902 may join a UE group based, at least in part, on the existence of a designated UE. As an example, the network may signal to the UE 902 an indication 912b of one or more designated UEs for multiple UE groups, e.g., including the designated UE 904. In some aspects, the network may signal to the UE 902 a list of clusters and/or a list of designated UEs for clusters. The network may indicate a corresponding designated UE (or cluster having a central UE) for a scheduled UE to join. In some aspects, the network may signal to the designated UE 904, or may configure the UE 904, to operate as a designated UE for a UE group. In some aspects, the designated UE may be referred to as a “center UE.” The term “center UE” is used herein to designate the UE that receives model updates from the other UEs of the group, and which provides a combined report for the UE group to the network. The designated UE may also be referred to by other terms, such as lead UE, head UE, primary UE, etc. While the designated UE may be in a somewhat central location of a UE group, the term “center UE” does not necessarily indicate that the UE is at a physical center of a UE group, and instead indicates that the center UE performs a central role for the UE group.

In some aspects, the network may indicate multiple designated UEs to the scheduled UE, and the UE may access or attempt to join a UE group with a closest designated UE or a closest cluster. As an example, the indication at 912b may indicate multiple designated UEs to the UE 902, and the designated UE 904 may be a closest designated UE of the multiple designated UEs indicated at 912b. In some aspects, the UE 902 may determine a closest designated UE based on a highest RSSI of sidelink communication from the multiple designated UEs. In some aspects, the UE 902 may determine a closest designated UE based on a highest cross link interference (CLI) of Uu communication from the multiple designated UEs.

In some aspects, the network may indicate multiple designated UEs to the scheduled UE, and the UE may access or attempt to join a UE group with a designated UE having a same scenario index as the scheduled UE. As an example, the indication at 912b may indicate multiple designated UEs to the UE 902, and the designated UE 904 (or the corresponding cluster) may share a scenario ID with the UE 902.

In some aspects, the network may indicate multiple designated UEs to the scheduled UE, and the UE may access or attempt to join a UE group with a designated UE having a same cell ID as the scheduled UE. As an example, the indication at 912b may indicate multiple designated UEs to the UE 902, and the designated UE 904 (or the corresponding cluster) may share a cell ID with the UE 902.

In some aspects, the UE may attempt to join a group with a designated UE based on any combination of the above described examples. For example, the UE may attempt to join the UE group having the same cell ID, same scenario and/or being closest in distance to the scheduled UE.

In some aspects, the network may indicate the designated UE(s) and/or cluster(s) to a UE in a FL configuration for the UE. Base on sidelink communication, the UE may determine a designated UE and/or a cluster to access. In some aspects, the UE may self-determine the designated UE and/or cluster based on the sidelink communication. As an example, if a higher capability UE (which may be referred to as regular UE) and a lower capability UE (e.g., which may be referred to as a low-tier UE) are scheduled for FL, the lower capability UE may join a UE group with a closest regular UE and/or the regular UE with the same scenario ID or in a same cell ID. In some aspects, the lower capability UE may dynamically join a group or cluster with a regular UE based on one or more criteria. In some aspects, the UE 902 may be a lower capability UE, and the designated UE 904 may be a higher capability UE. The higher capability UE may operate as the designated of the cluster/UE group, or may perform a central role, for the UE group including assisting lower capability UEs with FL. In order to form, or join a UE group, the UE and the designated UE may be within range for sidelink communication and may both support sidelink communication. The example cluster 1075 illustrates one or more lower capability UEs 1001 in a cluster 1075 with a higher capability UE 1003 as a designated UE.

The UE 902 and the UE 904 may exchange one or more sidelink messages in order for the UE 902 to join the UE group and/or for the UE group to be formed. FIG. 11 illustrates an example communication flow diagram 1100 showing example aspects of a clustering signaling procedure. The UE 1104 may correspond to the UE 902, and the UE 1106 may correspond to the UE 904. In some aspects, a network component, such as an FL manager node (which may correspond to the ML model manager 506 in FIG. 5) may configure the designated UE 1106, or otherwise indicate for the UE 1106 to operate as the designated UE 1106 for a UE group, at 1110. In some aspects, the network may configure, or otherwise transmit/indicate, one or more grouping rules, parameters, and/or criteria. In some aspects, the network may transmit the grouping criteria 1112 to the UE 1104. In other aspects, the transmission may be to multiple UEs. The rules or criteria 1112 may include any of the aspects described in connection with FIG. 9 (e.g., 910a or 910b).

As illustrated at 1114, the designated UE 1106 may transmit, e.g., broadcast, a sidelink message. In some aspects, the broadcast message may include information about the UE group and/or may indicate that the UE 1106 is the designated UE of the UE group. The UE 1104 may establish a sidelink connection, at 1114, with the designated UE 1106. After establishing the sidelink connection, the UE 1104 (which may be referred to as a scheduled UE due to an FL configuration to provide uplink ML module update reports) may determine whether to join/form a UE group and/or may identify a designated UE with which to join/form the UE group. The determination may be based on the rules configured by the network, e.g., at 1112, for example. At 1116, the UE 1104 sends a sidelink message to the designated UE 1106 to join the UE group and/or to form a cluster for FL model update reports.

In the example in FIG. 8, multiple UE groups/clusters may be formed based on various criteria. In some aspects, the network (e.g., the base station 850) may configure designated UEs 806, 820, and 812. The designated UEs 806, 820, and 812 may broadcast, multicast, or unicast a sidelink message to nearby UEs (e.g., nearby scheduled UEs that are configured for FL) and may build sidelink connections with the surrounding scheduled UEs. The designated UE 820 may be a UE of a user that is a bus passenger, or may be a UE associated with the bus 802 or removably coupled to the bus 802. The designated UE 820 may identify one or more UEs within a range (e.g., α) of the UE 820 based on RSSI measurements, and/or that share a scenario (e.g., mobility) with the UE 820. The designated UE 820 may build a UE group through sidelink signaling with the UEs within the bus meeting the criteria for UE grouping.

Although the UEs of the bus passengers and the vehicle UEs 810, 812, and 814, may be identified with a same scenario ID (e.g., high mobility), the vehicle UEs may be outside of the range a of the designated UE 820. Therefore, the vehicle UEs may not join the UE group with the designated UE 820. Instead, the vehicle UEs 810, 812, and 814 may form a UE group among the UEs 810, 812, and 814 with the UE 812 as the designated UE. Although the UE 806 may be configured with grouping rules, if one or more UEs do not match the clustering conditions, or rules/criteria for forming UE groups, the UE 806 may not form a UE group/cluster and may instead continue to provide individual model update reports (e.g., ungrouped model update reports).

The messages (e.g., 910a, 910b, 912a, 912b, 914, 1110, and/or 1112) from the network to the designated UE or scheduled UEs may be provided in RRC signaling. As an example of a FL message for a designated UE, the RRC signaling may include one or more bits indicating whether or not the UE is to operate as a designated UE. The RRC signaling may include one or more bit indicated whether the UE is a scheduled UE. The RRC signaling may include one or more bits indicating a maximum number of effective features for ML model update reporting for a UE group. Examples of a maximum number may include 0, 1, 2, 5, . . . . As an example, the network may provide such information to the designated UE 904 in a configuration to collect ML model updates from a UE group, at 914.

An example FL message for a scheduled UE (e.g., a UE configured to provide ML model updates based on local data) may include one or more bits that indicate whether or not the UE is to be grouped/clustered. The FL message may include one or more bits indicating at least one grouping rule or grouping criteria to be applied by the UE. The FL message may include one or more bits that indicate an RSSI threshold or other threshold for determining a range to a designated UE/cluster. In some aspects, the RSSI may correspond to 15 m, 20 m, 30 m, etc.

After a UE group/cluster is formed, at 916, the UE 902 transmits individual ML model update(s) to the designated UE 904 in a sidelink message. The designated UE 904 may receive ML model updates from multiple UEs, e.g., as shown at 919, and may merge the information from the individual ML model updates, at 920. The designated UE 1104 then reports the combine ML mode update, at 922. The network may use the ML mode update from one or more UE groups and/or individual UEs to update the ML mode. Then, the network transmits a ML model update, at 924a, 924b, and 924c. Although illustrated with multiple lines, the ML model update 924a, 924b, 924c may be a broadcast of the ML model update that is received by the designated UE 904 and the scheduled UEs 902 and 901.

FIG. 12 illustrates a communication flow diagram 1200 that shows example aspects of a designated UE combining, or merging individual ML model updates from UEs in the UE group, e.g., which may be applied at 920 in FIG. 9. FIG. 12 illustrates that a designated UE 1206 may broadcast information about the UE group and/or may establish a sidelink connection with the UE 1204, as illustrated at 1210, and with the UE 1202, as illustrated at 1212. The UEs 1202 and 1204 may evaluate UE grouping rules/criteria, at 1214. The grouping rules or criteria may include any of the aspects described in connection with FIG. 9. The UE 1204 may determine that the grouping rules/criteria are met, and may transmit and/or receive sidelink messages to join a UE group with the designated UE 1206, at 1216. The UE 1202 may determine that the grouping rules/criteria are not met and may not join a UE group with the designated UE 1206. At 1218, the UE 1204 may transmit a model update report to the designated UE 1206 over sidelink rather than to the network (e.g., base station 1208) over a Uu link, as reported by the UE 1202, at 1224.

At 1220, the designated UE 1206 may analyze, merge, and/or combine the ML updates 1218 and 1219 from multiple UEs in the UE group, e.g., the UE 1201 and 1204, among other potential UEs. As an example, the designated UE 1206 may analyze the difference among the model updates from the UEs in the UE group. The designated UE 1206 may extract the valuable model updates, e.g., a model update that is not redundant and that affects a model update of the global ML model. The designated UE 1206 may perform an estimation to obtain a difference among the individual model updates reported from the UEs in the UE group. In some aspects, the estimation may be referred to as model merging, and may be performed in order to extract one or more features to be reported to the network (e.g., one or more valuable features).

Various methods for model merging may be applied by the designated UE. As an example, if 5 scheduled UEs report FL model updates (M) to the designated UE 1206, e.g., M₁, M₂, M₃, M₄, M₅, the designated UE may determine an average (M) of the model updates.

$$\overline{M} = \frac{{M}_{1} + {M}_{2} + {M}_{3} + {M}_{4} + {M}_{5}}{5}$$

In this example, M̅ may be identified as the valuable feature, and the designated UE 1206 may report M̅ back to the network rather than multiple model updates.

Additionally, or alternatively, the designated UE 1206 may perform a correlation analysis, e.g., cosine similarity between model updates. As an example, the model updates M₁, M₂, M₃, M₄ may hold a larger similarity or at least a threshold similarly, e.g., cosine similarity>0.99. In other examples, a similarly threshold may be lower than 0.99. In this example, any of the model updates meeting the similarity criteria (e.g., M₁) can represent the valuable information of each of the model updates. Therefore, the designated UE 1206 may report one of model updates M₁, M₂, M₃, M₄.

In contrast, the model update M₅ may have a different distribution from the other model updates, e.g., cosine similarity<0.5. Therefore, the features of M₅ may be different than the features of M₁, M₂, M₃, M₄, and the designated UE may report M₅.

In this example, M₁ and M₅ may provide the valuable features of the reported models, and the designated UE may report M₁ and M₅ back to network, e.g., without reporting M₂, M₃, M₄.

FIG. 12 illustrates, at 1222, the designated UE 1206 providing a cluster model update, e.g., based on the combined analysis at 1220. The designated UE 1206 may report the extracted, valuable model update information to a FL server, or may indicate the UE whose model update may be more valuable for the network.

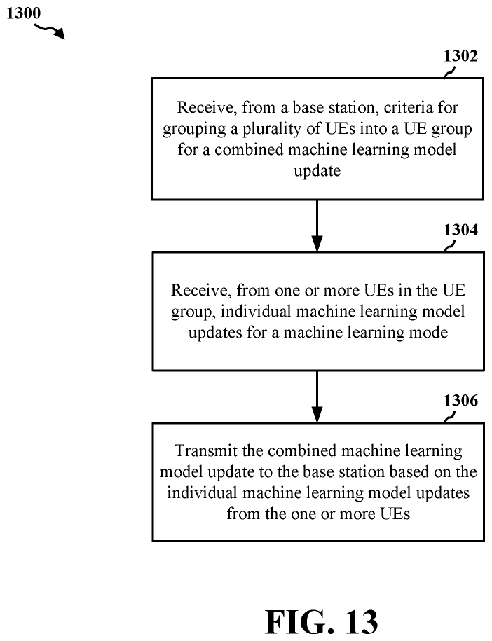

FIG. 13 is a flowchart 1300 of a method of wireless communication. The method may be performed by a UE (e.g., the UE 104, 350, 902, 1106, 1206; the device 402; the apparatus 1902; etc.), which may include the memory 360 and which may be the entire UE, e.g., UE 350, or a component of the UE 350, such as the TX processor 368, the RX processor 356, and/or the controller/processor 359.

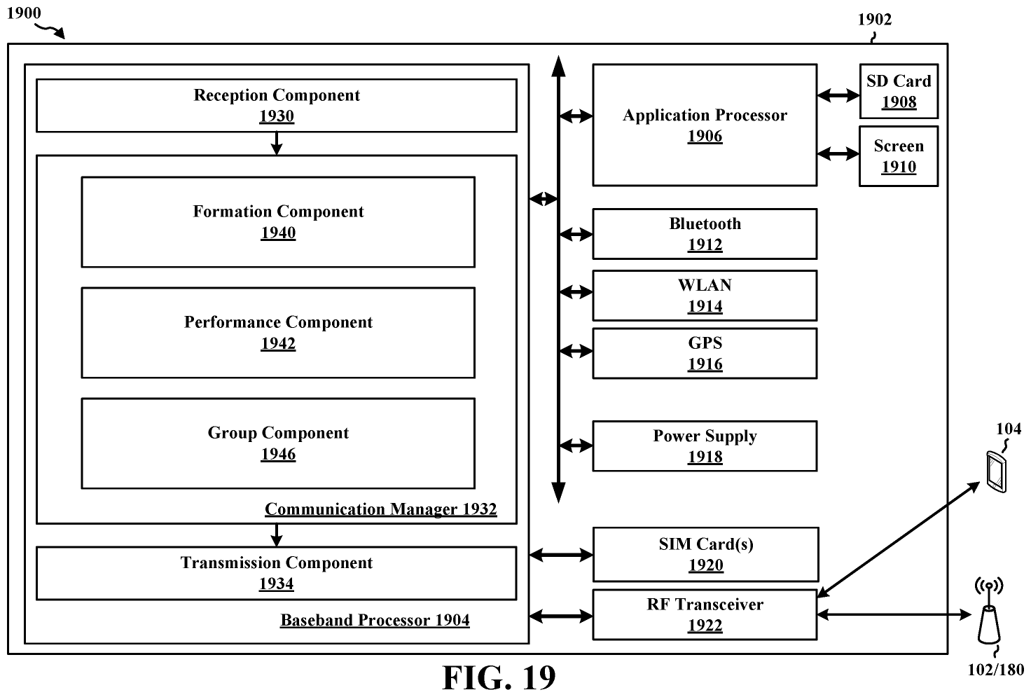

At 1302, the UE may receive, from a base station, one or more criteria for grouping a plurality of UEs into a UE group for a combined machine learning model update. For example, referring to FIG. 9, the UE 904 may receive, at 910a, UE grouping criteria from the base station 906. The reception, at 1302, may be performed by the reception component 1930 of the apparatus 1902 in FIG. 19.

At 1304, the UE may receive, from one or more UEs in the UE group, individual machine learning model updates for a machine learning model. For example, referring to FIG. 9, the UE 904 may receive, at 918, individual ML model updates from the UE 902. The reception, at 1304, may be performed by the reception component 1930 of the apparatus 1902 in FIG. 19.

At 1306, the UE may transmit the combined machine learning model update to the base station based on the individual machine learning model updates from the one or more UEs. For example, referring to FIG. 9, the UE 904 may transmit, at 922, a combined ML model update to the base station 906 based on the ML model update merger performed, at 920, by the UE 904. The transmission, at 1306, may be performed by the transmission component 1934 of the apparatus 1902 in FIG. 19.

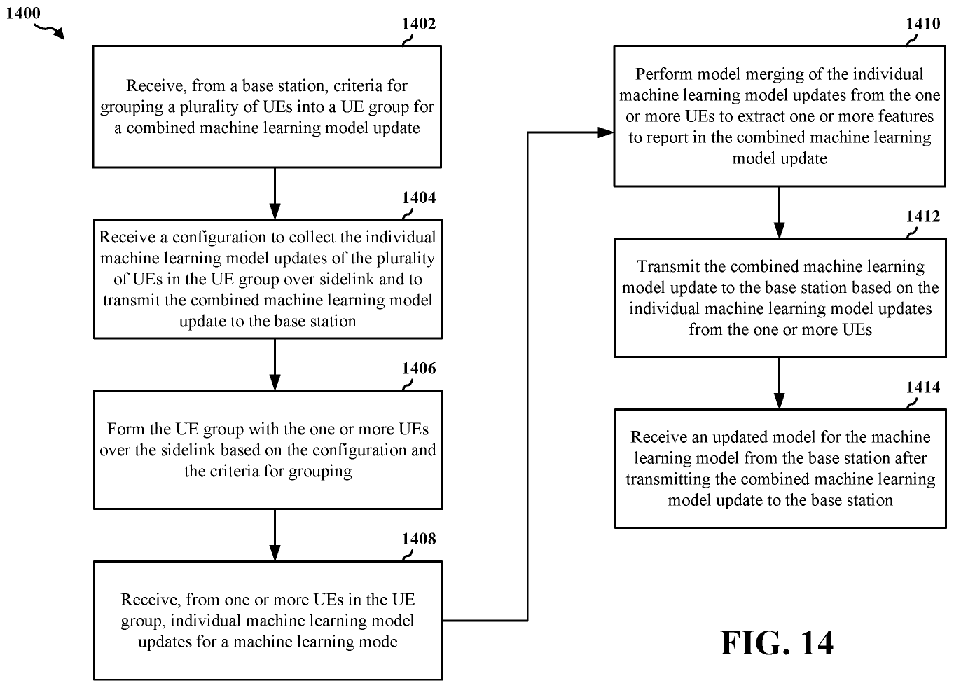

FIG. 14 is a flowchart 1400 of a method of wireless communication. The method may be performed by a UE (e.g., the UE 104, 350, 902, 1106, 1206; the device 402; the apparatus 1902; etc.), which may include the memory 360 and which may be the entire UE, e.g., UE 350, or a component of the UE 350, such as the TX processor 368, the RX processor 356, and/or the controller/processor 359.

At 1402, the UE may receive, from a base station, one or more criteria for grouping a plurality of UEs into a UE group for a combined machine learning model update. For example, referring to FIG. 9, the UE 904 may receive, at 910a, UE grouping criteria from the base station 906. The reception, at 1402, may be performed by the reception component 1930 of the apparatus 1902 in FIG. 19. The one or more criteria may identify at least one UE for the UE group. The one or more criteria may indicate one or more of a distance from the UE, a scenario identifier (ID), or a cell ID.

At 1404, the UE may receive a configuration to collect the individual machine learning model updates of the plurality of UEs in the UE group over sidelink and to transmit the combined machine learning model update to the base station. For example, referring to FIG. 9, the UE 904 may receive, at 914, a configuration to collect ML model updates from the UE group, such that the combined ML model update may be transmitted, at 922, to the base station 906. The reception, at 1404, may be performed by the reception component 1930 of the apparatus 1902 in FIG. 19.

At 1406, the UE may form the UE group with the one or more UEs over the sidelink based on the configuration and the criteria for grouping. For example, referring to FIG. 9, the UE 904 may form, at 916, a UE group with the UE 902 based on the UE grouping criteria received, at 910a, from the base station 906. The formation, at 1406, may be performed by the formation component 1940 of the apparatus 1902 in FIG. 19.

At 1408, the UE may receive, from one or more UEs in the UE group, individual machine learning model updates for a machine learning model. For example, referring to FIG. 9, the UE 904 may receive, at 918, individual ML model updates from the UE 902. The reception, at 1408, may be performed by the reception component 1930 of the apparatus 1902 in FIG. 19.

At 1410, the UE may perform model merging of the individual machine learning model updates from the one or more UEs to extract one or more features to report in the combined machine learning model update. For example, referring to FIG. 9, the UE 904 may perform, at 920, an ML model update merger based on the individual ML model updates received, at 918. The combined ML model update transmitted, at 922, to the base station 906 may be based on the ML model update merger performed, at 920. The performance, at 1410, may be performed by the performance component 1942 of the apparatus 1902 in FIG. 19.

At 1412, the UE may transmit the combined machine learning model update to the base station based on the individual machine learning model updates from the one or more UEs. For example, referring to FIG. 9, the UE 904 may transmit, at 922, the combined ML model update to the base station 906 based on the individual ML model updates received, at 918, from the UE 902. The transmission, at 1412, may be performed by the transmission component 1934 of the apparatus 1902 in FIG. 19. The combined machine learning model update may be based on an average between the individual machine learning model updates. The average may fuse the individual model updates based on a shared filter. The combined machine learning model update may be based on a similarity analysis between the individual machine learning model updates.

At 1414, the UE may receive an updated model for the machine learning model from the base station after transmitting the combined machine learning model update to the base station. For example, referring to FIG. 9, the UE 904 may receive, at 924a, an updated Ml model from the base station 906 after transmitting, at 922, the combined ML model update to the base station 906. The reception, at 1414, may be performed by the reception component 1930 of the apparatus 1902 in FIG. 19.

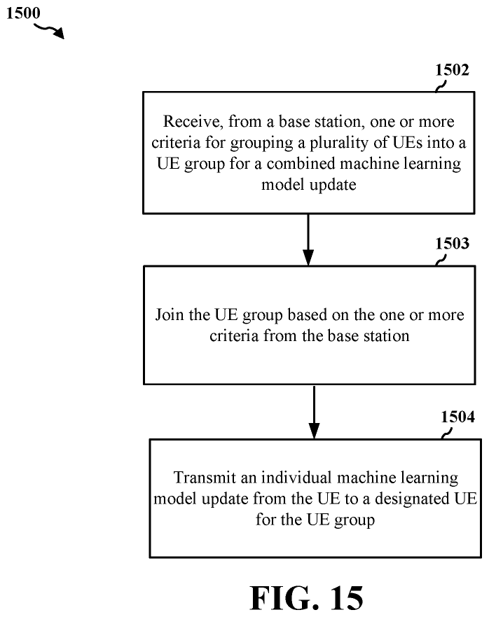

FIG. 15 is a flowchart 1500 of a method of wireless communication. The method may be performed by a UE (e.g., the UE 104, 350, 902, 1104, 1204; the device 402; the apparatus 1902; etc.), which may include the memory 360 and which may be the entire UE, e.g., UE 350, or a component of the UE 350, such as the TX processor 368, the RX processor 356, and/or the controller/processor 359.

At 1502, the UE may receive, from a base station, one or more criteria for grouping a plurality of UEs into a UE group for a combined machine learning model update. For example, referring to FIG. 9, the UE 902 may receive, at 910b, UE grouping criteria from the base station 906. The reception, at 1502, may be performed by the reception component 1930 of the apparatus 1902 in FIG. 19.

At 1503, the UE may join the UE group based on the one or more criteria from the base station.

At 1504, the UE may transmit an individual machine learning model update from the UE to a designated UE for the UE group. For example, referring to FIG. 9, the UE 902 may transmit, at 918, individual ML model updates to the designated UE 904 based on the UE grouping criteria received, at 910b, from the base station 906. The transmission, at 1504, may be performed by the transmission component 1934 of the apparatus 1902 in FIG. 19.

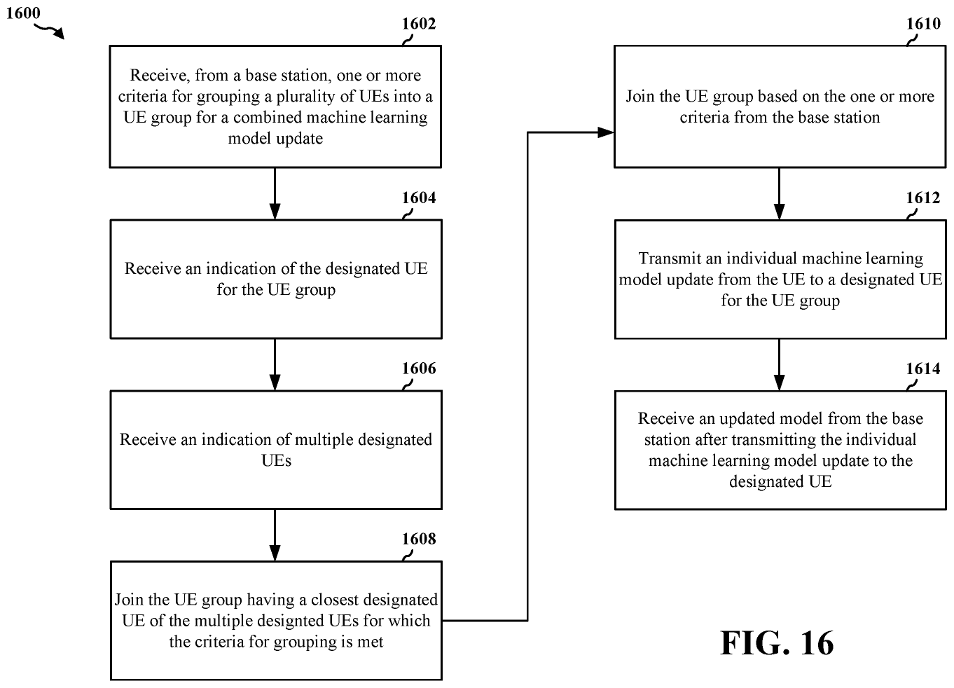

FIG. 16 is a flowchart 1600 of a method of wireless communication. The method may be performed by a UE (e.g., the UE 104, 350, 902, 1104, 1204; the device 402; the apparatus 1902; etc.), which may include the memory 360 and which may be the entire UE, e.g., UE 350, or a component of the UE 350, such as the TX processor 368, the RX processor 356, and/or the controller/processor 359.

At 1602, the UE may receive, from a base station, one or more criteria for grouping a plurality of UEs into a UE group for a combined machine learning model update. For example, referring to FIG. 9, the UE 902 may receive, at 910b, UE grouping criteria from the base station 906. The reception, at 1502, may be performed by the reception component 1930 of the apparatus 1902 in FIG. 19. The one or more criteria may identify at least one UE for the UE group. The one or more criteria may indicate one or more of a distance from the UE, a scenario identifier (ID), or a cell ID.

At 1604, the UE may receive an indication of the designated UE for the UE group. For example, referring to FIG. 9, the UE 902 may receive, at 912b, an indication of the designated UE 904 from the base station 906. The reception, at 1604, may be performed by the reception component 1930 of the apparatus 1902 in FIG. 19. The indication may be from the base station. The indication may be from the designated UE.

At 1606, the UE may receive an indication of multiple designated UEs. For example, referring to FIG. 9, the UE 902 may receive, at 912b, an indication of multiple designated UEs, such as the designated UE 904, from the base station 906. The reception, at 1606, may be performed by the reception component 1930 of the apparatus 1902 in FIG. 19.

At 1608, the UE may join the UE group having a closest designated UE of the multiple designated UEs for which the one or more criteria for grouping is met. For example, referring to FIG. 9, the UE 902 may join, at 916, a UE group that includes the designated UE 904. The joining, at 1608, may be performed by the group component 1946 of the apparatus 1902 in FIG. 19.

At 1610, the UE may join the UE group based on the one or more criteria from the base station. For example, the UE may join, over sidelink, the UE group with the designated UE based on the indication and the criteria being met for the UE. For example, referring to FIG. 9, the UE 902 may join, at 916, a UE group that includes the designated UE 904 based on the UE grouping criteria received, at 910b, from the base station 906. The joining, at 1610, may be performed by the group component 1946 of the apparatus 1902 in FIG. 19.

At 1612, the UE may transmit an individual machine learning model update from the UE to a designated UE for the UE group. For example, referring to FIG. 9, the UE 902 may transmit, at 918, individual Ml model updates to the designated UE 904 based on the UE grouping criteria received, at 910b, from the base station 906. The transmission, at 1612, may be performed by the transmission component 1934 of the apparatus 1902 in FIG. 19.

At 1614, the UE may receive an updated model from the base station after transmitting the individual machine learning model update to the designated UE. For example, referring to FIG. 9, the UE 902 may receive, at 924b, an updated ML model from the base station 906 after transmitting, at 918, the individual ML model updates to the designated UE 904. The reception, at 1614, may be performed by the reception component 1930 of the apparatus 1902 in FIG. 19.

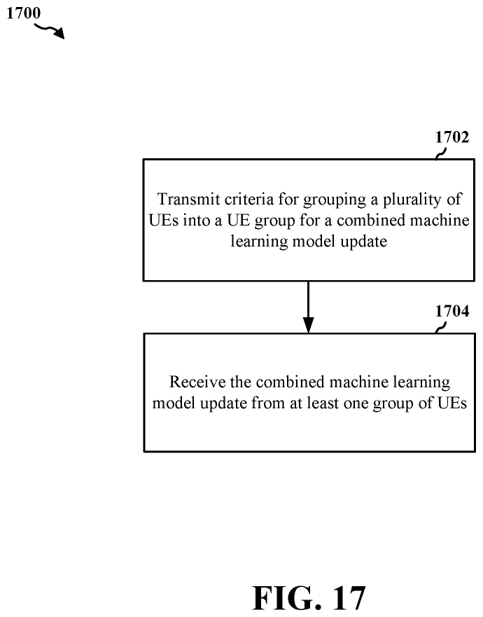

FIG. 17 is a flowchart 1700 of a method of wireless communication. The method may be performed by a base station (e.g., the base station 102, 310, 906, 1102, 1208; the device 404; the apparatus 2002; etc.), which may include the memory 376 and which may be the entire base station e.g., 310, or a component of the base station 310, such as the TX processor 316, the RX processor 370, and/or the controller/processor 375.

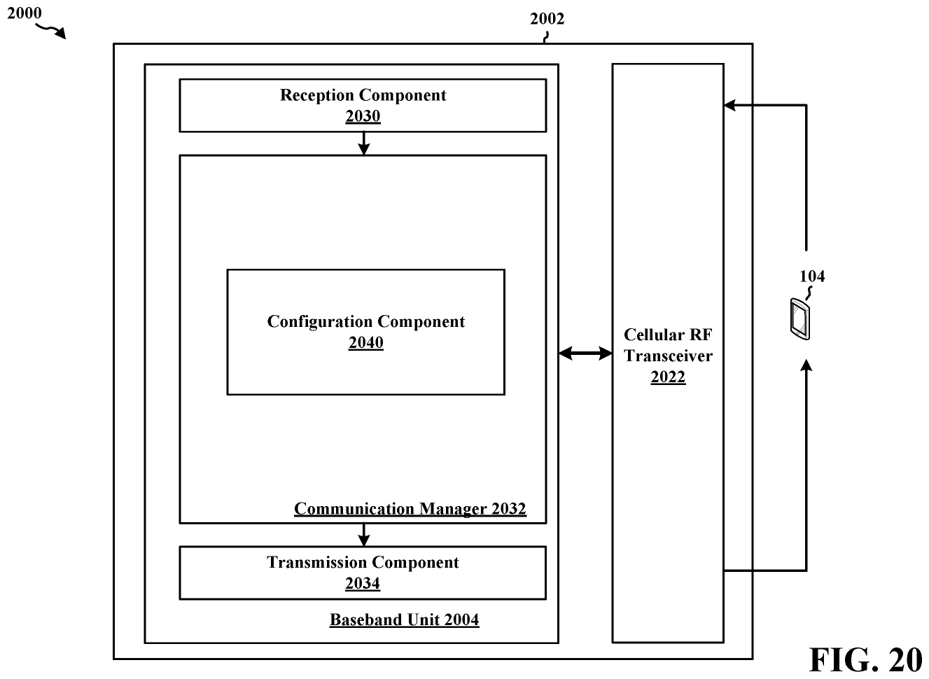

At 1702, the base station may transmit one or more criteria for grouping a plurality of UEs into a UE group for a combined machine learning model update. For example, referring to FIG. 9, the base station 906 may transmit, at 910a-910b, UE grouping criteria to the UE 902 and the designated UE 904. The transmission, at 1702, may be performed by the transmission component 2034 of the apparatus 2002 in FIG. 20.

At 1704, the base station may receive the combined machine learning model update from at least one group of UEs. For example, referring to FIG. 9, the base station 906 may receive, at 922, the combined ML model update from the designated UE 904. The reception, at 1704, may be performed by the reception component 2030 of the apparatus 2002 in FIG. 20.

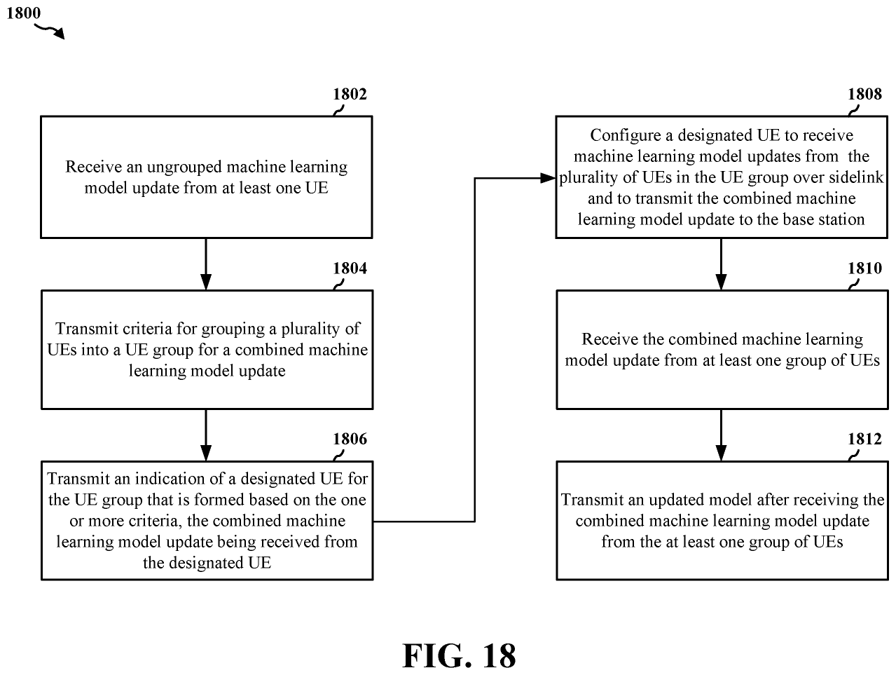

FIG. 18 is a flowchart 1800 of a method of wireless communication. The method may be performed by a base station (e.g., the base station 102, 310, 906, 1102, 1208; the device 404; the apparatus 2002; etc.), which may include the memory 376 and which may be the entire base station e.g., 310, or a component of the base station 310, such as the TX processor 316, the RX processor 370, and/or the controller/processor 375.

At 1802, the base station may receive an ungrouped machine learning model update from at least one UE. For example, referring to FIG. 9, the base station 906 may receive, at 908a-908b, ungrouped ML model updates from the UE 902 and the designated UE 904. The reception, at 1802, may be performed by the reception component 2030 of the apparatus 2002 in FIG. 20.

At 1804, the base station may transmit one or more criteria for grouping a plurality of UEs into a UE group for a combined machine learning model update. For example, referring to FIG. 9, the base station 906 may transmit, at 910a-910b, UE grouping criteria to the UE 902 and the designated UE 904. The transmission, at 1804, may be performed by the transmission component 2034 of the apparatus 2002 in FIG. 20. The one or more criteria may identify at least one to form the UE group. The one or more criteria may indicate a range with reference to a designated UE. The one or more criteria may indicate a scenario identifier (ID). The one or more criteria may indicate a cell identifier (ID). The one or more criteria may indicate one or more of a range from a designated UE, a scenario identifier (ID), or a cell ID.

At 1806, the base station may transmit of a designated UE for the UE group that is formed based on the one or more criteria, the combined machine learning model update being received from the designated UE. For example, referring to FIG. 9, the base station 906 may transmit, at 912a-912b, an indication of the designated UE 904 based on the UE grouping criteria transmitted, at 910a-910b, to the UE 902 and the designated UE 904. The transmission, at 1806, may be performed by the transmission component 2034 of the apparatus 2002 in FIG. 20.

At 1808, the base station may configure a designated UE to receive machine learning model updates from the plurality of UEs in the UE group over sidelink and to transmit the combined machine learning model update to the base station. For example, referring to FIG. 9, the base station 906 may configure, at 914, the designated UE 904 to collect ML model updates from the UE group, such that the designated UE 904 may transmit, at 922, the combined ML model update to the base station 906. The configuration, at 1808, may be performed by the configuration component 2040 of the apparatus 2002 in FIG. 20.

At 1810, the base station may receive the combined machine learning model update from at least one group of UEs. For example, referring to FIG. 9, the base station 906 may receive, at 922, the combined ML model update from the designated UE 904. The reception, at 1810, may be performed by the reception component 2030 of the apparatus 2002 in FIG. 20.

At 1812, the base station may transmit an updated model after receiving the combined machine learning model update from the at least one group of UEs. For example, referring to FIG. 9, the base station 906 may transmit, at 924a-924b, an updated ML model to the UE 902 and the designated UE 904 after receiving, at 922, the combined ML model update from the designated UE 904. The transmission, at 1812, may be performed by the transmission component 2034 of the apparatus 2002 in FIG. 20.

FIG. 19 is a diagram 1900 illustrating an example of a hardware implementation for an apparatus 1902. The apparatus 1902 may be a UE, a component of a UE, or may implement UE functionality. In some aspects, the apparatus 1902 may include a baseband processor 1904 (also referred to as a modem) coupled to a RF transceiver 1922. In some aspects, the baseband processor 1904 may be a cellular baseband processor, and the RF transceiver 1922 may be a cellular RF transceiver. In some aspects, the apparatus 1902 may further include one or more subscriber identity modules (SIM) cards 1920, an application processor 1906 coupled to a secure digital (SD) card 1908 and a screen 1910, a Bluetooth module 1912, a wireless local area network (WLAN) module 1914, a Global Positioning System (GPS) module 1916, or a power supply 1918. The baseband processor 1904 communicates through the RF transceiver 1922 with the UE 104 and/or BS 102/180. The baseband processor 1904 may include a computer-readable medium/memory. The computer-readable medium/memory may be non-transitory. The baseband processor 1904 is responsible for general processing, including the execution of software stored on the computer-readable medium/memory. The software, when executed by the baseband processor 1904, causes the baseband processor 1904 to perform the various functions described supra. The computer-readable medium/memory may also be used for storing data that is manipulated by the baseband processor 1904 when executing software. The baseband processor 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the baseband processor 1904. The baseband processor 1904 may be a component of the UE 350 and may include the memory 360 and/or at least one of the TX processor 368, the RX processor 356, and the controller/processor 359. In one configuration, the apparatus 1902 may be a modem chip and include just the baseband processor 1904, and in another configuration, the apparatus 1902 may be the entire UE (e.g., see 350 of FIG. 3) and include the additional modules of the apparatus 1902.

The reception component 1930 is configured, e.g., as described in connection with 1302, 1304, 1402, 1404, 1408, 1414, 1502, 1602, 1604, 1606, and 1614, to receive, from a base station, criteria for grouping UEs for a combined machine learning model update; to receive a configuration to collect machine learning model updates from a group of UEs over sidelink and to transmit the combined machine learning model update to the base station; to receive individual machine learning model updates from one or more UEs; to receive an updated model from the base station after transmitting the combined machine learning model update to the base station; to receive, from a base station, criteria for grouping UEs for a combined machine learning model update; to receive an indication of the designated UE for the group of UEs; to receive an indication of multiple designated UEs; and to receive an updated model from the base station after transmitting the individual machine learning model update to the designated UE.

The communication manager 1932 includes a formation component 1940 that is configured, e.g., as described in connection with 1406, to form a group with the one or more UEs over the sidelink based on the configuration and the criteria for grouping. The communication manager 1932 further includes a performance component 1942 that is configured, e.g., as described in connection with 1410, to perform model merging of the individual machine learning model updates from the one or more UEs to extract one or more features of a machine learning model update-the combined machine learning model update includes the one or more features extracted from the individual machine learning model updates. The communication manager 1932 further includes a group component 1946 that is configured, e.g., as described in connection with 1608 and 1610, to join the group of UEs having a closest designated UE of the multiple designated UEs for which the criteria for grouping is met; and to join, over sidelink, a group with the designated UE based on the indication and the criteria being met for the UE.

The transmission component 1934 is configured, e.g., as described in connection with 1306, 1412, 1504, and 1612, to transmit the combined machine learning model update to the base station based on the individual machine learning model updates from the one or more UEs; and to transmit an individual machine learning model update from the UE to a designated UE for a group of UEs based on the criteria from the base station.

The apparatus may include additional components that perform each of the blocks of the algorithm in the flowcharts of FIGS. 13-16. As such, each block in the flowcharts of FIGS. 13-16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1902 may include a variety of components configured for various functions. In one configuration, the apparatus 1902, and in particular the baseband processor 1904, includes means for receiving, from a base station, criteria for grouping UEs for a combined machine learning model update; means for receiving individual machine learning model updates from one or more UEs; and means for transmitting the combined machine learning model update to the base station based on the individual machine learning model updates from the one or more UEs. The apparatus 1902 further includes means for receiving a configuration to collect machine learning model updates from a group of UEs over sidelink and to transmit the combined machine learning model update to the base station. The apparatus 1902 further includes means for forming a group with the one or more UEs over the sidelink based on the configuration and the criteria for grouping. The apparatus 1902 further includes means for performing model merging of the individual machine learning model updates from the one or more UEs to extract one or more features of a machine learning model update, the combined machine learning model update including the one or more features extracted from the individual machine learning model updates. The apparatus 1902 further includes means for receiving an updated model from the base station after transmitting the combined machine learning model update to the base station.

In a further configuration, the apparatus 1902, and in particular the baseband processor 1904, includes means for receiving, from a base station, criteria for grouping UEs for a combined machine learning model update; and means for transmitting an individual machine learning model update from the UE to a designated UE for a group of UEs based on the criteria from the base station. The apparatus 1902 further includes means for receiving an indication of the designated UE for the group of UEs. The apparatus 1902 further includes means for joining, over sidelink, a group with the designated UE based on the indication and the criteria being met for the UE. The apparatus 1902 further includes means for receiving an indication of multiple designated UEs; and means for joining the group of UEs having a closest designated UE of the multiple designated UEs for which the criteria for grouping is met. The apparatus 1902 further includes means for receiving an updated model from the base station after transmitting the individual machine learning model update to the designated UE.

The means may be one or more of the components of the apparatus 1902 configured to perform the functions recited by the means. As described supra, the apparatus 1902 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 20 is a diagram 2000 illustrating an example of a hardware implementation for an apparatus 2002. The apparatus 2002 may be a base station, a component of a base station, or may implement base station functionality. In some aspects, the apparatus 2002 may include a baseband unit 2004. The baseband unit 2004 may communicate through a RF transceiver 2022 with the UE 104. The baseband unit 2004 may include a computer-readable medium/memory. The baseband unit 2004 is responsible for general processing, including the execution of software stored on the computer-readable medium/memory. The software, when executed by the baseband unit 2004, causes the baseband unit 1804 to perform the various functions described supra. The computer-readable medium/memory may also be used for storing data that is manipulated by the baseband unit 2004 when executing software. The baseband unit 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the baseband unit 2004. The baseband unit 2004 may be a component of the base station 310 and may include the memory 376 and/or at least one of the TX processor 316, the RX processor 370, and the controller/processor 375.

The reception component 2030 is configured, e.g., as described in connection with 1704, 1802, and 1810, to receive an ungrouped machine learning model update from at least one UE; and to receive the combined machine learning model update from at least one group of UEs. The communication manager 2032 includes a configuration component 2040 that is configured, e.g., as described in connection with 1808, to configure a designated UE to collect machine learning model updates from a group of UEs over sidelink and to transmit the combined machine learning model update to the base station. The transmission component 2034 is configured, e.g., as described in connection with 1702, 1804, 1806, and 1812, to transmit criteria for grouping UEs for a combined machine learning model update; to transmit an indication of a designated UE for a group of UEs formed based on the criteria-the combined machine learning model update is received from the designated UE; and to transmit an updated model after receiving the combined machine learning model update from the at least one group of UEs.

The apparatus may include additional components that perform each of the blocks of the algorithm in the flowcharts of FIGS. 17-18. As such, each block in the flowcharts of FIGS. 17-18 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2002 may include a variety of components configured for various functions. In one configuration, the apparatus 2002, and in particular the baseband unit 2004, includes means for transmitting criteria for grouping UEs for a combined machine learning model update; and means for receiving the combined machine learning model update from at least one group of UEs. The apparatus 2002 further includes means for transmitting an indication of a designated UE for a group of UEs formed based on the criteria, the combined machine learning model update being received from the designated UE. The apparatus 2002 further includes means for configuring a designated UE to collect machine learning model updates from a group of UEs over sidelink and to transmit the combined machine learning model update to the base station. The apparatus 2002 further includes means for receiving an ungrouped machine learning model update from at least one UE. The apparatus 2002 further includes means for transmitting an updated model after receiving the combined machine learning model update from the at least one group of UEs.

The means may be one or more of the components of the apparatus 2002 configured to perform the functions recited by the means. As described supra, the apparatus 2002 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a UE, comprising: receiving, from a base station, one or more criteria for grouping a plurality of UEs into a UE group for a combined machine learning model update; receiving, from one or more UEs in the UE group, individual machine learning model updates for a machine learning model; and transmitting the combined machine learning model update to the base station based on the individual machine learning model updates from the one or more UEs.

In aspect 2, the method of aspect 1 further includes that the one or more criteria identifies at least one UE for the UE group.

In aspect 3, the method of aspect 1 or aspect 2 further includes that the criteria indicates one or more of a distance from the UE, a scenario ID, or a cell ID.

In aspect 4, the method of any of aspects 1-3 and further includes receiving a configuration to collect the individual machine learning model updates of the plurality of UEs in the UE group over sidelink and to transmit the combined machine learning model update to the base station.

In aspect 5, the method of any of aspects 1-4 and further includes forming the UE group with the one or more UEs over the sidelink based on the configuration and the one or more criteria for grouping.

In aspect 6, the method of any of aspects 1-5 and further includes performing model merging of the individual machine learning model updates from the one or more UEs to extract one or more features to report in the combined machine learning model update.

In aspect 7, the method of any of aspects 1-6 and includes that the combined machine learning model update is based on an average between the individual machine learning model updates.

In aspect 8, the method of any of aspects 1-7 and includes that the combined machine learning model update is based on a similarity analysis between the individual machine learning model updates.

In aspect 9, the method of any of aspects 1-8 and further includes receiving an updated model for the machine learning model from the base station after transmitting the combined machine learning model update to the base station.

Aspect 10 is a method of wireless communication at a UE, comprising: receiving, from a base station, one or more criteria for grouping a plurality of UEs into a UE group for a combined machine learning model update; joining the UE group based on the one or more criteria from the base station; and transmitting an individual machine learning model update from the UE to a designated UE for the UE group.

In aspect 11, the method of aspect 10 and includes that the one or more criteria is received over an access link with the base station and the individual machine learning model update is transmitted to the designated UE over sidelink.

In aspect 12, the method of aspect 10 or aspect 11 further includes that the one or more criteria identify at least one UE for the UE group.

In aspect 13, the method of any of aspects 10-12 and includes that the one or more criteria indicates one or more of a distance from the UE, a scenario ID, or a cell ID.

In aspect 14, the method of any of aspects 10-13 and further includes receiving an indication of the designated UE for the UE group.

In aspect 15, the method of any of aspects 10-14 and includes that the indication is from the base station.

In aspect 16, the method of any of aspects 10-15 and includes that the indication is from the designated UE.

In aspect 17, the method of any of aspects 10-16 and further includes joining, over sidelink, the UE group with the designated UE based on the indication and the criteria being met for the UE.

In aspect 18, the method of any of aspects 10-17 and further includes receiving an indication of multiple designated UEs; and joining the group of UEs having a closest designated UE of the multiple designated UEs for which the one or more criteria for grouping is met.

In aspect 19, the method of any of aspects 10-18 and further includes receiving an updated model from the base station after transmitting the individual machine learning model update to the designated UE.

Aspect 20 is a method of wireless communication at a base station, comprising: transmitting one or more criteria for grouping a plurality of UEs into a UE group for a combined machine learning model update; and receiving the combined machine learning model update from at least one group of UEs.

In aspect 21, the method of aspect 20 further includes that the one or more criteria identifies at least one to form the UE group.

In aspect 22, the method of aspects 20 or 21 and includes that the one or more criteria indicates a range with reference to a designated UE.

In aspect 23, the method of any of aspects 20-22 and includes that the one or more criteria indicates a scenario ID.

In aspect 24, the method of any of aspects 20-23 and includes that the one or more criteria indicates a cell ID.

In aspect 25, the method of any of aspects 20-24 and includes that the one or more criteria indicates one or more of a range from a designated UE, a scenario ID, or a cell ID.

In aspect 26, the method of any of aspects 20-25 and further includes transmitting an indication of a designated UE for the UE group that is formed based on the one or more criteria, the combined machine learning model update being received from the designated UE.

In aspect 27, the method of any of aspects 20-26 and further includes configuring a designated UE to receive machine learning model updates from the plurality of UEs in the UE group over sidelink and to transmit the combined machine learning model update to the base station.

In aspect 28, the method of any of aspects 20-27 and further includes receiving an ungrouped machine learning model update from at least one UE.

In aspect 29, the method of any of aspects 20-28 and further includes transmitting an updated model after receiving the combined machine learning model update from the at least one group of UEs.

Aspect 30 is an apparatus for wireless communication configured to perform the method of any of aspects 1-9.

In aspect 31, the apparatus of aspect 30 further includes at least one antenna.

In aspect 32, the apparatus of aspect 30 further includes at least one transceiver.

Aspect 33 is an apparatus for wireless communication including means for performing the method of any of aspects 1-9.

In aspect 34, the apparatus of aspect 33 further includes at least one antenna.

In aspect 35, the apparatus of aspect 33 further includes at least one transceiver.

Aspect 36 is a non-transitory computer-readable storage medium storing computer executable code, the code when executed by at least one processor causes the at least one processor to perform the method of any of aspects 1-9.

Aspect 37 is an apparatus for wireless communication configured to perform the method of any of aspects 10-19.

In aspect 38, the apparatus of aspect 37 further includes at least one antenna.

In aspect 39, the apparatus of aspect 37 further includes at least one transceiver.

Aspect 40 is an apparatus for wireless communication including means for performing the method of any of aspects 10-19.

In aspect 41, the apparatus of aspect 40 further includes at least one antenna.

In aspect 42, the apparatus of aspect 40 further includes at least one transceiver.

Aspect 43 is a non-transitory computer-readable storage medium storing computer executable code, the code when executed by at least one processor causes the at least one processor to perform the method of any of aspects 10-19.

Aspect 44 is an apparatus for wireless communication configured to perform the method of any of aspects 20-29.

In aspect 45, the apparatus of aspect 44 further includes at least one antenna.

In aspect 46, the apparatus of aspect 44 further includes at least one transceiver.

Aspect 47 is an apparatus for wireless communication including means for performing the method of any of aspects 20-29.

In aspect 48, the apparatus of aspect 47 further includes at least one antenna.

In aspect 49, the apparatus of aspect 47 further includes at least one transceiver.

Aspect 50 is a non-transitory computer-readable storage medium storing computer executable code, the code when executed by at least one processor causes the at least one processor to perform the method of any of aspects 20-29.

What is claimed is:

1. An apparatus for wireless communication at a user equipment (UE), comprising:
a memory; and
at least one processor coupled to the memory, the memory and the at least one processor configured to:
receive, from a base station, one or more criteria for grouping a plurality of UEs into a UE group for a combined machine learning model update;
receive, from one or more UEs in the UE group, individual machine learning model updates for a machine learning model; and
transmit the combined machine learning model update to the base station based on the individual machine learning model updates from the one or more UEs.

2. The apparatus of claim 1, wherein the one or more criteria identifies at least one UE for the UE group.

3. The apparatus of claim 1, wherein the one or more criteria indicate one or more of a distance from the UE, a scenario identifier (ID), or a cell ID.

4. The apparatus of claim 1, wherein the memory and the at least one processor are further configured to:
receive a configuration to collect the individual machine learning model updates of the plurality of UEs in the UE group over sidelink and to transmit the combined machine learning model update to the base station.

5. The apparatus of claim 4, wherein the memory and the at least one processor are further configured to:
form the UE group with the one or more UEs over the sidelink based on the configuration and the one or more criteria for grouping.

6. The apparatus of claim 1, wherein the memory and the at least one processor are further configured to:
perform model merging of the individual machine learning model updates from the one or more UEs to extract one or more features to report in the combined machine learning model update.

7. The apparatus of claim 6, wherein the combined machine learning model update is based on an average between the individual machine learning model updates.

8. The apparatus of claim 6, wherein the combined machine learning model update is based on a similarity analysis between the individual machine learning model updates.

9. The apparatus of claim 1, wherein the memory and the at least one processor are further configured to:
receive an updated model for the machine learning model from the base station after transmitting the combined machine learning model update to the base station.

10. An apparatus for wireless communication at a user equipment (UE), comprising:
a memory; and
at least one processor coupled to the memory, the memory and the at least one processor configured to:
receive, from a base station, one or more criteria for grouping a plurality of UEs into a UE group for a combined machine learning model update;
joining the UE group based on the one or more criteria from the base station; and
transmit an individual machine learning model update from the UE to a designated UE for the UE group.

11. The apparatus of claim 10, wherein to receive the one or more criteria, the memory and the at least one processor are configured to receive the one or more criteria over an access link with the base station and to transmit the individual machine learning model update, the memory and the at least one processor are further configured to transmit the individual machine learning model update to the designated UE over sidelink.

12. The apparatus of claim 10, wherein the one or more criteria identify at least one UE for the UE group.

13. The apparatus of claim 10, wherein the one or more criteria indicate one or more of a distance from the UE, a scenario identifier (ID), or a cell ID.

14. The apparatus of claim 10, wherein the memory and the at least one processor are further configured to:
receive an indication of the designated UE for the UE group.

15. The apparatus of claim 14, wherein the indication is from the base station.

16. The apparatus of claim 14, wherein the indication is from the designated UE.

17. The apparatus of claim 14, wherein the memory and the at least one processor are further configured to:
join, over sidelink, the UE group with the designated UE based on the indication and the one or more criteria being met for the UE.

18. The apparatus of claim 10, wherein the memory and the at least one processor are further configured to:
receive an indication of multiple designated UEs, wherein to join the UE group, the memory and the at least one processor are further configured to:
join the UE group having a closest designated UE of the multiple designated UEs for which the one or more criteria for grouping is met.

19. The apparatus of claim 10, wherein the memory and the at least one processor are further configured to:
receive an updated model from the base station after transmitting the individual machine learning model update to the designated UE.

20. An apparatus for wireless communication at a base station, comprising:
a memory; and
at least one processor coupled to the memory, the memory and the at least one processor configured to:
transmit one or more criteria for grouping a plurality of user equipments (UEs) into a UE group for a combined machine learning model update; and
receive the combined machine learning model update from at least one group of UEs.

21. The apparatus of claim 20, wherein the one or more criteria identifies at least one to form the UE group.

22. The apparatus of claim 20, wherein the one or more criteria indicate a range with reference to a designated UE.

23. The apparatus of claim 20, wherein the one or more criteria indicate a scenario identifier (ID).

24. The apparatus of claim 20, wherein the one or more criteria indicate a cell identifier (ID).

25. The apparatus of claim 20, wherein the one or more criteria indicate one or more of a range from a designated UE, a scenario identifier (ID), or a cell ID.

26. The apparatus of claim 20, wherein the memory and the at least one processor are further configured to:
transmit an indication of a designated UE for the UE group that is formed based on the one or more criteria, the combined machine learning model update being received from the designated UE.

27. The apparatus of claim 20, wherein the memory and the at least one processor are further configured to:
configure a designated UE to receive machine learning model updates from the plurality of UEs in the UE group over sidelink and to transmit the combined machine learning model update to the base station.

28. The apparatus of claim 20, wherein the memory and the at least one processor are further configured to:
receive an ungrouped machine learning model update from at least one UE.

29. The apparatus of claim 20, wherein the memory and the at least one processor are further configured to:
transmit an updated model after receiving the combined machine learning model update from the at least one group of UEs.

30. A method of wireless communication at a user equipment (UE), comprising:
receiving, from a base station, one or more criteria for grouping a plurality of UEs into a UE group for a combined machine learning model update;
receiving, from one or more UEs in the UE group, individual machine learning model updates for a machine learning model; and
transmitting the combined machine learning model update to the base station based on the individual machine learning model updates from the one or more UEs.
